(19) United States
(12) Patent Application Publication
(10) Pub. No.: US 2024/0295131 A1
(43) Pub. Date: Sep. 5, 2024

(54) SYSTEMS AND METHODS FOR ADDITIVE MANUFACTURING USING AN ADJUSTABLE FORM

(71) Applicant: Building Machines, Inc., Hudson, MA (US)

(72) Inventors: Jeremy Samuel De Bonet, Southborough, MA (US); Nicholas Charles McMahon, Bolton, MA (US)

(21) Appl. No.: 18/707,854

(22) PCT Filed: Oct. 1, 2021
(86) PCT No.: PCT/US2021/053236

§ 371 Date: May 6, 2024

Related U.S. Application Data
(60) Provisional application No. 63/086,812, filed on Oct. 2, 2020.

(51) Int. Cl. E04G 11/22; B33Y 10/00; B33Y 30/00; B33Y 40/00; B33Y 70/00; E04B 1/35; E04G 21/04; E04G 21/06

(52) U.S. Cl. CPC E04G 11/22; E04B 1/3505; E04G 21/0463; E04G 21/065; B33Y 10/00; B33Y 30/00; B33Y 40/00; B33Y 70/00

(57) ABSTRACT

The present disclosure relates to systems and methods for additive manufacturing of objects by molding or casting materials using a dynamically configurable form. A head for dispensing material includes an adjustable form configurable to define a forming chamber into which the material is dispensed. A method for additive manufacturing includes moving the head to a plurality of positions corresponding to a plurality of dispense locations in a build volume, configuring the adjustable form to shape the forming chamber for each of the plurality of dispense locations; and casting a three-dimensional object. Casting the three-dimensional object comprises dispensing a portion of the material into the forming chamber at each of the plurality of dispense locations.

### RELATED APPLICATIONS

This application claims the benefit of priority under 35 U.S.C. § 119(e) to U.S. Provisional Patent Application No. 63/086,812, entitled “Continuous Casting of Material Through Computer Controlled Dynamic Form Adjustment,” filed Oct. 2, 2020, which is hereby fully incorporated by reference herein.

### TECHNICAL FIELD

The present disclosure relates generally to additive manufacturing. More particularly, embodiments relate to systems and methods for casting materials using a dynamically adjustable form. Even more particularly, some embodiments of the present disclosure relate to methods and systems for building large structures, buildings, infrastructure, or components thereof.

### BACKGROUND

Traditional methods of building concrete structures require workers to manually build a fixed form—typically a framework of wood, metal, or composite—into which the wet concrete is poured and then consolidated. Once the concrete sets sufficiently, the form is manually removed. Large structures are created by separately casting sections, which requires complex reinforcement schemes to securely join separate sections as well as additional labor to manually reset the forms for each section. This workflow requires large amounts of precise and repetitive labor and often results in structural failure or leak-prone cold joints between the separately cast sections.

In recent years, additive manufacturing has become increasingly important in the construction industry. In particular, 3D printing for construction has been gaining popularity for building small structures of less than 1000 square feet (92 square meters). 3D printers additively manufacture objects by extruding a paste layer-by-layer through a print head. The building structure is formed when the paste layers are cured.

The walls of 3D printed building structures are relatively weak compared to structures formed using traditional methods. Despite being referred to as 3D “concrete” printers, the 3D printers used in construction typically extrude, not concrete, but a mortar-based paste that is weaker than concrete. Moreover, 3D concrete printers continuously extrude the paste and do not have a form to hold the extruded paste, and as a consequence the extruded paste cannot be consolidated. Thus, the interfaces between the adjacent layers of cured paste are not mechanically connected and, as a result, have poor bonding strength and toughness relative to properly consolidated cast concrete, which can lead to delamination and debonding when the interfaces between layers as they age, weather, or are subjected to external driving forces. Furthermore, because the width of a paste layer is limited by the flowability and other material properties of the paste, the walls formed by 3D printing tend to be made up of multiple relatively thin wythes rather than the solid concrete walls created via traditional cast-in-place or precast methods. Building structures prepared by 3D printing are thus more prone to damage or collapse and may not be up to building code in a majority of applications in many locales.

As such, improved systems and methods for additive manufacturing are desired.

### SUMMARY

Attention is thus directed to the systems and methods for additive manufacturing disclosed herein.

Embodiments of the present disclosure provide improved systems and methods for additive manufacturing. Embodiments utilize a dynamically adjustable form to continually cast material while changing locations to build a structure. The dynamically adjustable form allows the material to be both cast alongside and above previously cast material and consolidated together with the previously cast sections. In particular embodiments, the adjustable form is used to cast a cementitious material, such as concrete, to build various structures such as, but not limited to, concrete walls (e.g., basement walls, stem walls, finished walls, or other types of walls), stairs, footings, piles, culverts, beams, doubleT, singleT, columns, septic tanks, buildings, infrastructure, distributions boxes, manholes, or other structures.

More particularly, the material used to build a structure is introduced into the adjustable form and consolidated in the adjustable form as needed to ensure that the material fills the form a desired amount to have a shape at least partially defined by the form or previously dispensed material, is void free, and has mechanically intermixed with horizontally or vertically adjacent previously cast sections. For example, when material is dispensed at a location that is not adjacent to previously dispensed material, the material may take on a shape that is at least partially defined by the form. When the material is dispensed at a location that has previously dispensed material on one or more sides but is not fully surrounded by the previously dispensed material, the newly dispensed material can take on a shape that is at least partially defined by the adjustable form and the adjacent previously dispensed material. In yet another example, when previously dispensed material fully surrounds the newly dispensed material, the newly dispensed material can have a shape defined by the previously dispensed material. When the material has stiffened sufficiently to hold its shape without the adjustable form, the adjustable form is moved to a new location, potentially being reconfigured into a new shape for the new location. Additional material is dispensed at the new location and consolidated in the form as needed. When the material has stiffened sufficiently to hold its shape without the form, the form can be removed. The process of moving and reconfiguring the adjustable form and casting and consolidating the material in the adjustable form is repeated to create the desired structure.

As mentioned, various embodiments include consolidating the material within the adjustable form. Consolidating the material in the adjustable form can include consolidating both the newly dispensed material and previously dispensed material so that the matrix of material components is evenly mixed and void-free within and across the newly dispensed material and the previously dispensed material, thereby consolidating them together into one monolithic, contiguous, and joint free composition of material. As an example, when building a structure layer-by-layer, material in the layer currently being formed and the material from the layer directly below can be consolidated together into one monolithic, contiguous, and joint-free layer.

One general aspect of the present disclosure includes a method of additive manufacturing. The method of additive manufacturing includes moving a head to a plurality of positions corresponding to a plurality of dispense locations in a build volume. The head may include an adjustable form configurable to define a forming chamber for forming a material at the plurality of dispense locations. The method also includes configuring the adjustable form to shape the forming chamber for each of the plurality of dispense locations. The method also includes casting a three-dimensional object, casting the three-dimensional object may include dispensing a portion of the material into the forming chamber at each of the plurality of dispense locations. The method may include consolidating the portion of the material dispensed into the forming chamber at each of the plurality of dispense locations. In some implementations, the material is cast to form a monolithic three-dimensional object.

Dispensing the portion of the material into the forming chamber at each of the plurality of dispense locations may include dispensing a first portion of the material at a first dispense location. Consolidating the portion of the material dispensed into the forming chamber at each of the plurality of dispense locations may include consolidating the first portion of the material. Configuring the adjustable form to shape the forming chamber for each of the plurality of dispense locations may include configuring the forming chamber to have a first configuration prior to dispensing the first portion of the material and reconfiguring the forming chamber to a second configuration for a second dispense location from the plurality of dispense locations.

Dispensing the portion of the material into the forming chamber at each of the plurality of dispense locations may include dispensing a second portion of the material at a second dispense location. Dispensing the second portion of the material at the second dispense location may include dispensing the second portion of the material adjacent to the first portion of the material. Dispensing the second portion of the material at the second dispense location may include dispensing the second portion of the material on top of the first portion of the material. Consolidating the portion of the material dispensed into the forming chamber at each of the plurality of dispense locations may include consolidating the second portion of the material to cause the second portion of the material to take the shape defined by the forming chamber and consolidating the first portion of the material and the second portion of the material together to form a monolithic structure.

Dispensing the portion of the material at each of the plurality of dispense locations may include building the three-dimensional object by stacking a plurality of layers. The method may include positioning the adjustable form so that the adjustable form extends below a top surface of a previous layer when forming the current layer on top of the previous layer. Consolidating the portion of the material dispensed into the forming chamber at each of the plurality of dispense locations may include consolidating a portion of the current layer and a portion of the previous layer below the portion of the current layer to intermix the portion of the current layer and the portion of the previous layer.

The adjustable form may include a plurality of form sections and where configuring the adjustable form may include selectively actuating form sections from the plurality of form segments to configure the forming chamber. Configuring the adjustable form to shape the forming chamber for each of the plurality of dispense locations may include: based on a determination that a dispense configuration of the adjustable form for a next dispense location has a first form section that is raised which is not raised in a current configuration of the adjustable form, raising the first form section prior to moving the adjustable form from a current dispense location to a next dispense location; and after moving the adjustable form from the current dispense location to the next dispense location as the new current dispense location and prior to dispensing material at the new current dispense location, reconfiguring the adjustable form for the new current dispense location, where reconfiguring the adjustable form for the new current dispense location may include lowering a second form section.

Consolidating the portion of the material dispensed into the forming chamber at each of the plurality of dispense locations may include lowering a vibrator into the portion of the material and activating the vibrator. The method further may include raising the vibrator prior to moving the head from a current position to a next position.

The method may include using the adjustable form to level a top surface of a current layer of the material. Configuring the adjustable form may include automatically configuring the adjustable form.

Other embodiments of this aspect include corresponding computer systems, apparatus, and computer programs recorded on non-transitory computer readable media. A computer system can be configured to perform particular operations or actions by virtue of having software, firmware, hardware, or a combination of them installed on the computer system that in operation causes or cause a system to perform the actions to cast the three-dimensional object. A computer program can be configured to perform particular operations or actions by virtue of including instructions that, when executed by data processing apparatus, cause a system to perform the actions to cast the three-dimensional object. One embodiment includes a computer program product comprising a non-transitory, computer-readable medium storing a set of computer-executable instructions, the set of computer-executable instructions comprising instructions for controlling a system (e.g., an additive manufacturing system) to cast a three-dimensional object.

Another general aspect includes a system for additive manufacturing. The system includes a head, which may include an adjustable form for casting a material. The adjustable form is configurable to define a forming chamber. The adjustable form may include a plurality of form sections that are selectively movable to create the forming chamber in a plurality of shapes. The system also includes a head positioning system to position the head in build volume. The system may include a material source to provide the material to the head. The head may include a consolidation element. In one embodiment, the consolidation element comprises a form vibrator. In addition, or in the alternative, the consolidation element comprises a rod vibrator. Other forms of consolidation elements may also be used.

Other embodiments of this aspect include corresponding computer systems, apparatus, and computer programs recorded on one or more computer storage devices, to cause the system to perform the actions of the methods. One embodiment includes a computer system in communication with the head, the head positioning system, and the material source. The computer system may comprise a processor and a non-transitory, computer-readable medium storing instructions executable by the processor for controlling the head positioning system, the head, and the material source to cast a three-dimensional object using the head. Casting the three-dimensional object may include: moving the head to a plurality of positions corresponding to a plurality of dispense locations in a build volume; automatically configuring the adjustable form to shape the forming chamber for each of the plurality of dispense locations; and dispensing a portion of the material into the forming chamber at each of the plurality of dispense locations.

As mentioned, the head may include a vibrator. Casting the three-dimensional object may include using the vibrator to consolidate the portion of the material dispensed into the adjustable form at each of the plurality of dispense locations. Casting the three-dimensional object may include using the vibrator to consolidate adjacent portions of the material into a monolithic structure. The vibrator may be a form vibrator that vibrates the adjustable form. The vibrator may be another type of vibrator, such as, but not limited to a rod vibrator. The vibrator may be movable in the forming chamber from a retracted position to a lowered position.

The plurality of form sections may include a plurality of retractable blades. The head may include a plurality of actuators coupled to the plurality of retractable blades to raise and lower the plurality of retractable blades to selectively define the forming chamber. The forming chamber may include a central chamber portion and an adjacent chamber portion selectively joined to the central chamber portion based on a configuration of the plurality of form sections. According to one embodiment, the head dispenses material from a top of the central chamber portion.

Another general aspect may include a device for additive manufacturing. The device also includes an adjustable form for casting a material. The adjustable form is configurable to define a forming chamber. The adjustable form may include a plurality of form sections that are selectively movable to create the forming chamber in a plurality of shapes. The head may include a material delivery path for delivering material to the forming chamber.

Implementations may include one or more of the following features. The device may include a consolidation element to consolidate the material in the forming chamber. The device may include a vibrator for consolidating the material in the forming chamber. The vibrator may be a form vibrator that vibrates the automatically adjustable form. The vibrator may comprise another type of vibrator, such as a rod vibrator. The vibrator may be movable within the forming chamber from a retracted position to a lowered position. The forming chamber may include a central chamber portion and an adjacent chamber portion selectively joined to the central chamber portion based on a configuration of the plurality of form sections. The material delivery path, according to one embodiment, is open to a top of the central chamber portion. The adjustable form may be automatically adjustable to reconfigure the forming chamber. The plurality of form sections may include a plurality of retractable blades. The device may include a plurality of actuators coupled to the plurality of retractable blades to raise and lower the plurality of retractable blades to selectively define the forming chamber.

In some embodiments of systems, methods and apparatuses, the material used is a material that liquifies essentially immediately or otherwise quickly when consolidation energy is applied and stiffens essentially immediately or otherwise quickly upon the cessation of the application of the consolidation energy. The material may have a curing profile so that it begins to set immediately or almost immediately upon being dispensed. In some embodiments, the material has a rheology so that it becomes stiff and non-deforming enough to hold its shape upon being dispensed into the forming chamber but has sufficient shear thinning properties such that it liquifies as soon as consolidation energy is applied and returns to a shape-holding state upon the cessation of the application of consolidation energy. In some embodiments, the material is a cementitious material.

Embodiments described herein enable a device which provides the key benefit of eliminating the need for fixed formwork and automating associated processes in casting and thereby: 1) significantly reducing the labor associated with the creation or assembly of forms required to build objects or structures; 2) increasing the accuracy and repeatability of the casting and consolidation processes; and 3) allowing for the monolithic one-piece casting of structures which are too large for traditional approaches.

Embodiments can use computer-numeric control (CNC) or other automated control processes, including automated control processes that utilize sensor feedback, to increase the accuracy and repeatability of the casting process.

One advantage provided by some embodiments described herein is the ability to dynamically adjust the mixture of cementitious material components, fiber reinforcement, or the rate of admixtures at the time of casting. This can be used to increase the strength of concrete at areas that will experience increased stress in the structure, such as above large apertures, where it is not economically advantageous to do so at other locations in the structure.

These, and other, aspects of the disclosure will be better appreciated and understood when considered in conjunction with the following description and the accompanying drawings. It should be understood, however, that the following description, while indicating various embodiments of the disclosure and numerous specific details thereof, is given by way of illustration and not of limitation. Many substitutions, modifications, additions, or rearrangements may be made within the scope of the disclosure without departing from the spirit thereof, and the disclosure includes all such substitutions, modifications, additions, or rearrangements.

### BRIEF DESCRIPTION OF THE DRAWINGS

The drawings accompanying and forming part of this specification are included to depict certain aspects of the disclosure. It should be noted that the features illustrated in the drawings are not necessarily drawn to scale. A more complete understanding of the disclosure and the advantages thereof may be acquired by referring to the following description, taken in conjunction with the accompanying drawings in which like reference numbers indicate like features and wherein:

FIG. 1 is a diagrammatic representation of one embodiment of an additive manufacturing system;

FIG. 2 is a diagrammatic representation of a top view of one embodiment of a head;

FIG. 3 is a diagrammatic representation of an orthographic three-dimensional view of one embodiment of the head of FIG. 2;

FIG. 4A is a diagrammatic representation of one embodiment of a head in a first configuration for an example first location;

FIG. 4B is a diagrammatic representation of a top view of one embodiment of the adjustable form at the example first location;

FIG. 4C is a diagrammatic representation of one embodiment of consolidating dispensed material;

FIG. 4D is a diagrammatic representation of one embodiment of the portion of the object formed by depositing material at the first location.

FIG. 4E is a diagrammatic representation of one embodiment of the adjustable form configured for movement to an example second location;

FIG. 5A is a diagrammatic representation of one embodiment of the adjustable form in another configuration for dispensing material at the example second location;

FIG. 5B is a diagrammatic representation of a top view of one embodiment of the adjustable form 202 at the second location;

FIG. 5C is a diagrammatic representation of a top view of one embodiment of the adjustable form with additional material having been dispensed at the second location;

FIG. 5D is a diagrammatic representation of one embodiment of consolidating material at the second location;

FIG. 5E is a diagrammatic representation of one embodiment of the portion of the object being created having been extended;

FIG. 6A is a diagrammatic representation of one embodiment of an adjustable form configured in another configuration for movement to a third location and FIG. 6B is a diagrammatic representation of a top view of one embodiment of the adjustable form in the configuration of FIG. 6A.

FIG. 7A is a diagrammatic representation of one embodiment of the adjustable form at the third location;

FIG. 7B is a diagrammatic representation of a top view of one embodiment of the adjustable form at the third location;

FIG. 7C is a diagrammatic representation of a top view of one embodiment of the adjustable form at the third location with additional material having been dispensed to extend the portion of the object being created;

FIG. 7D is a diagrammatic representation of a top view of one embodiment of the adjustable form at a fourth location with additional material having been dispensed to extend the portion of the object being created;

FIG. 7E is a diagrammatic representation of a top view of one embodiment of the adjustable form at a fifth example location with additional material having been dispensed to extend the portion of the object being created;

FIG. 8A is a diagrammatic representation of one embodiment of the adjustable form in another configuration and at a sixth example location;

FIG. 8B is a diagrammatic representation of a top view of one embodiment of the adjustable form with material dispensed at the sixth location to extend the portion of the object being created;

FIG. 9A is a diagrammatic representation of one embodiment of the adjustable form in yet another configuration and at a seventh example location;

FIG. 9B is a diagrammatic representation of a top view of one embodiment of the adjustable form with material dispensed at the seventh location to extend the portion of the object being created;

FIG. 10A is a diagrammatic representation of a top view of one embodiment of the adjustable form in yet another configuration to allow movement to an eighth example location;

FIG. 10B is a diagrammatic representation of a top view of one embodiment of the adjustable form having moved to the eighth example location;

FIG. 11A is a diagrammatic representation of one embodiment of the adjustable form in in yet another configuration and at the eighth example location;

FIG. 11B is a diagrammatic representation of a top view of one embodiment of the adjustable form with material dispensed at the eighth location to extend the portion of the object being created;

FIG. 12A is a diagrammatic representation of one embodiment of the adjustable form in another configuration and at a ninth location;

FIG. 12B is a diagrammatic representation of a top view of one embodiment of the adjustable form with material dispensed at the ninth location to extend the portion of the object being created;

FIG. 13A is a diagrammatic representation of one embodiment of dispensing new material into the adjustable form and at a tenth location, which is above the first location, to vertically extend the portion of the object being created;

FIG. 13B is a diagrammatic representation of one embodiment of consolidating the dispensed material;

FIG. 13C is a diagrammatic representation of one embodiment of a subsection of the portion of the object being created;

FIG. 14 illustrates one embodiment of the adjustable form moving from the tenth location to another location, which is above the second location;

FIG. 15 is a diagrammatic representation of one embodiment of forming an object;

FIG. 16 is a diagrammatic representation of another embodiment of forming an object;

FIG. 17 is a diagrammatic representation of another embodiment of a head;

FIG. 18 is a diagrammatic representation of an isometric view of one embodiment of a head;

FIG. 19 is a diagrammatic representation of a front view of one embodiment of the head of FIG. 18;

FIG. 20 is a cross-sectional view of the embodiment of FIG. 19;

FIG. 21 is a diagrammatic representation of a bottom view of one embodiment of the head;

FIG. 22 is a diagrammatic representation of one embodiment of a blade assembly;

FIG. 23 is a cross-sectional view of the embodiment of FIG. 21;

FIG. 24A is a diagrammatic representation of another embodiment of a head and FIG. 24B is a bottom view of the embodiment of FIG. 24A;

FIG. 25A is a diagrammatic representation of yet another embodiment of a head and FIG. 25B illustrates one embodiment of a form section;

FIG. 26 is a flowchart illustrating one embodiment of a method for additively manufacturing an object;

FIG. 27 is a diagrammatic representation of one embodiment of a computing environment;

FIG. 28 depicts a wall additively constructed as described herein but using manual positioning of an adjustable form and manual consolidation, and without leveling the top layer. The wall does not have cold seams between the layers and is cast as a monolithic structure.

### DETAILED DESCRIPTION

Embodiments and the various features and advantageous details thereof are explained more fully with reference to the non-limiting embodiments that are illustrated in the accompanying drawings and detailed in the following description. Descriptions of well-known starting materials, processing techniques, components and equipment are omitted so as not to unnecessarily obscure the embodiments in detail. It should be understood, however, that the detailed description and the specific examples are given by way of illustration only and not by way of limitation. Various substitutions, modifications, additions and/or rearrangements within the spirit and/or scope of the underlying inventive concept will become apparent to those skilled in the art from this disclosure.

As mentioned, what is desired are improved systems and methods for additive manufacturing. Even more particularly, what is desired are systems and methods for casting of materials. To those ends, among others, attention is now directed to the systems and methods for additive manufacturing described herein.

Embodiments described herein provide systems and methods for manufacturing of objects by molding or casting of materials using an adjustable form having a cavity shape that can be dynamically changed for various locations at which material is to be cast. For example, the device can be controlled per a 3D design defined within a computer program.

According to one embodiment, the adjustable form is moved to a position corresponding to a dispense location at which material is to be cast. Before, after or during movement to the position, the adjustable form is configured so that the forming chamber has a shape suitable for the dispense location. The material is cast at the location using the form. More particularly, the material is dispensed (e.g., poured, injected using applied force or pressure, or otherwise dispensed) into the forming chamber and consolidated as needed. As will be appreciated, consolidating a material reduces the internal friction in the material, allowing the material to flow. For example, a cementitious material can be consolidated to reduce the internal friction of the material and liquify the material so that it flows and settles under the force of gravity, which may be aided by other forces in some embodiments. According to one embodiment, the material is consolidated so that it takes on a shape that is at least partially defined by the adjustable form or previously dispensed material and is void free. For example, the material can be consolidated so that it takes on a shape that has at least one finished surface as defined by the adjustable form. In some embodiments, the material is consolidated so that it will fill a central void created by all surrounding deposited materials of a structure and ultimately have a finished surface on all sides. Further, the material may be consolidated so that it mechanically intermixes with horizontally or vertically adjacent previously cast sections. The form can be removed once the material has stiffened to a shape-holding state. This may occur, for example, after consolidation is complete. For purposes of this application, a “shape-holding state” is a state in which the material is sufficiently stable to maintain its shape without a form. In a particular embodiment, the shape-holding state is a zero-slump state.

Additional material can then be cast at a new location to additively build on to the structure being created. As such, the adjustable form can be moved to a new position to create an additional portion of the structure being created. The adjustable form is potentially reconfigured to change the shape of the forming chamber for the new location. In various embodiments, the reconfiguration of the adjustable form is performed before, after, or during movement to the new location. In some cases, the adjustable form is reconfigured into a movement configuration suitable for moving to the new location and then reconfigured into a casting configuration suitable for casting the material at the new location. The additional material is dispensed at the new location and consolidated so as to create a structure, which may be a portion of the overall structure being built, with the previously cast material. The process may be repeated until the desired shape or structure is obtained. Embodiments described herein can be utilized to create a contiguous and seamless structure.

To this end, the system for additive manufacturing comprises an adjustable form that defines a forming chamber into which material is dispensed. The shape of the forming chamber is adjusted so as to create a volume that defines a small portion of a structure. The adjustable form is moved to a position at which that portion of the structure is desired (before, after, or during reconfiguring the adjustable form for that position). Material is automatically dispensed into the adjustable form and consolidated as needed. By this process, a portion of the structure can be cast. Once the material is sufficiently stable to maintain a shape without support of the form, if necessary, the adjustable form is first reconfigured to allow it to be moved or removed without colliding with the cast material; then the adjustable form is moved or removed. The cavity shape is reconfigured if necessary for the next portion of the structure, the adjustable form moved to the next position (before, after, or during reconfiguring the adjustable form for that position), and material dispensed and consolidated as needed at the new location. By repeating this process of continually adjusting the forming chamber, moving the adjustable form, dispensing and consolidating additional material, an entire object can be made. In some embodiments, the object may be a building structure or other architectural structure created at a building or construction site. In other embodiments the object may be a precast component created off-site that is later transported to and assembled or placed on site after curing.

One example application is the construction of structures made from concrete or other cementitious materials using a casting form having an adjustable shape and position. A system automatically and continually dispenses cementitious material into the adjustable casting form and consolidates the material in the form. More particularly, the system continually dispenses and consolidates material in a dynamically formed and positioned forming chamber to extend previously created portions of a structure until the entire structure is formed. According to one embodiment, the shape and position of the casting form are adjusted per instructions defined by a program run on a controlling computer.

While embodiments described herein are discussed primarily in the context of casting cementitious materials, it will be appreciated that other embodiments may be adapted for other castable materials, such as, but not limited to, plastics, metals, plasters, or mortars.

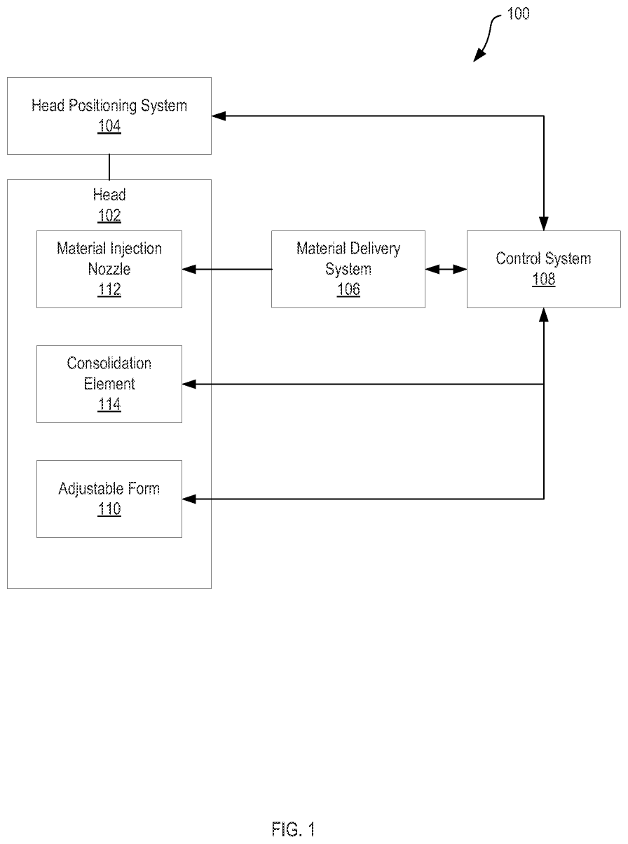

FIG. 1 is a diagrammatic representation of one embodiment of an additive manufacturing system 100 for casting a material, such as a paste or other semi-liquid material, that sets after being dispensed at a location. The material used may comprise a matrix of material components. In some embodiments, the additive manufacturing system 100 is adapted to dispense cementitious materials. More particularly, in accordance with some embodiments, the additive manufacturing system 100 is a 3D concrete casting system.

The additive manufacturing system 100 includes a head 102 to dispense material to a work area, a head positioning system 104 to position the head 102. The head 102 can be fluidly connected to a material source, such as a material delivery system 106 that provides material to the head 102. A control system 108 controls the head 102, the head positioning system 104, and the material delivery system 106.

The head 102 comprises an adjustable form 110 that is configurable to define a forming chamber having various shapes. Material is dispensed into the forming chamber via a material delivery path 112, which can comprise any suitable flow path through which material can be directed to the forming chamber. Material delivery path 112 may be defined, for example, by a hose, pipe, machined flow path or other components or combinations thereof. In some embodiments, the material delivery path 112 may include a nozzle through which the material to be dispensed flows. In some embodiments, separate constituent ingredients of the material may be transported separately or in subsets along delivery path 112, and then combined prior to being dispensed. In some embodiments, the head 102 further includes a consolidation element 114.

The head 102 is movable in a 3D build volume by the head positioning system 104 so that material can be dispensed at desired locations. The adjustable form 110 comprises a plurality of form sections (also referred to as wall segments) that define the inner surfaces of the forming chamber. The form sections can be raised and lowered to change the shape of the adjustable form, and more particularly, to change the shape of the forming chamber. The form sections may have a variety of shapes, sizes, and reconfiguration mechanics Examples of form sections include, but are not limited to, blades, slats, blocks, or other components that can be used to define a forming chamber.

The shape of the forming chamber can be configurable to match the portion of the structure that is desired at a particular location by selectively moving the form sections up or down. Thus, when material is dispensed at a dispense location, it is dispensed into a cavity created by the current configuration of the adjustable form 110. The shape of the forming chamber can be dynamically changed for different dispense locations.

In one embodiment, the form sections are of sufficient length that the finished structure is cast without adjusting the height of the head 102. In another embodiment, the form sections allow for a first layer of material, such as concrete, to be cast in place, followed by subsequent layers where the head is positioned above the preceding layer, and additional material is cast to form the current layer and consolidated together with the preceding layer to form a seamless, joint free, and mechanically interlocked substructure. The process is repeated until the final height of the structure is achieved.

As discussed, some embodiments include consolidating the material dispensed into the forming chamber. Various methods of consolidation known or developed in the art may be used, including, but not limited to, vibration-based consolidation, consolidation using electromagnetic radiation, consolidation using magnetic fields, chemical consolidation, or other types of consolidation or combinations thereof.

Consolidation allows the material to settle under the action of the stimulating energy and gravity into a shape at least partially defined by the adjustable mold or previously dispensed material. In addition, or in the alternative, to allowing settlement under gravity, other forces may be applied to aid settlement. Consolidation can also be used to join newly dispensed material with previously dispensed material. In one embodiment, consolidation is performed across newly dispensed material and previously dispensed material so that, for example, the matrix of material components is evenly mixed and void-free within and across the newly dispensed material and the previously dispensed material. More particularly, in some embodiments, consolidation is applied to consolidate newly dispensed material and previously dispensed material together into a monolithic, contiguous, and joint free composition of material.

In the illustrated embodiment, the head 102 includes a consolidation element 114. The consolidation element may include, for example, an internal vibrator (such as one or more rod vibrators), a form vibrator, an electromagnetic radiation generator, a magnetic field generator, or other component usable to consolidate the dispensed material. In some embodiments, the consolidation element 114 comprises an internal vibrator that can be positioned in the forming chamber, a form vibrator that vibrates adjustable form 110, or another type of consolidation element, or combinations thereof. In one embodiment, consolidation element 114 comprises a plurality of vibrators that can be lowered into the material in the forming chamber and vibrated to consolidate the material. When consolidation is complete, the vibrators are retracted. In some embodiments, the consolidation element 114 is adapted to consolidate both the newly dispensed material as well as material adjacent to the newly dispensed material. In addition, or in the alternative, to using a consolidation element 114 incorporated in the head 102, consolidation may be performed by human laborers or additional automated equipment.

The head positioning system 104 is adapted to position the head 102 in a three-dimensional build volume. The head positioning system 104 may have a variety of forms. In one embodiment, the head positioning system comprises an overhead gantry having X, Y and Z stages. In another embodiment, the head may be positioned by a series of cables attached to controllable spools. As the cables wind around the spool the head moves in position. Simultaneously adjusting one or more spools translates the head in X, Y, Z space. Other examples of head positioning systems include, but are not limited to, a robotic arm, an overhead crane, a boom truck, a SCARA arm, a Delta robot, or a ground-based robot. The head positioning system 104 may comprise multiple positioning systems. In one embodiment, the head 102 may be coarsely positioned by one system and finely positioned by a different position.

The material delivery system 106 is connected to the material delivery path 112 and may comprise a bulk material hopper or other material storage unit and pumps or other devices to deliver material to the adjustable form via the material delivery path 112. The material delivery system 106 may include mixers or other components to add admixtures. In some embodiments, the material delivery system 106 is an injection system that injects material using applied force or pressure. The material delivery system 106 may be located on or inside of the head 102 or at another location and is fluidly connected to the forming chamber of the adjustable form 110 by the material delivery path 112. In other embodiments, the material is manually poured into the adjustable form 110.

The control system 108, according to one embodiment, comprises a computer system running software to control the head 102, the head positioning system 104, and material delivery system 106. In particular, the control system 108 controls the head positioning system 104 to position the head 102 desired positions, the head 102 so that adjustable form 110 has desired configurations, and material delivery system 106 to provide material, which is dispensed through head 102. Further, the control system 108 controls the consolidation element 114.

In one embodiment of operation, the control system 108 controls the head positioning system 104 to position the head 102 at a desired position in a build volume based on a design of a resulting structure. Before, during or after moving the head 102 to the desired position, the control system 108 controls the head 102 to adjust the adjustable form 110 so that the forming chamber into which material is to be dispensed has a configuration for casting the material at that dispense location. According to one embodiment, the cavity shape of the forming chamber is adjusted so as to create a volume that defines a portion of the structure being formed. With the head 102 at the desired position and the adjustable form 110 in the desired configuration, the control system 108 controls the material delivery system 106 to provide material to head 102. The material is delivered to the forming chamber via the material delivery path 112. In some embodiments, the control system 108 dynamically adjusts the mixture of cementitious material components, fiber reinforcement, or the rate of admixtures at the time of casting.

The consolidation element 114 is then activated to consolidate the material that was dispensed. The consolidation element 114 imparts energy to the material for the purpose of consolidating the material. The material can be consolidated so that it takes on a shape that is at least partially defined by the adjustable form or previously dispensed material, is void free, and has mechanically intermixed with horizontally or vertically adjacent previously cast sections. The consolidation element is removed and, according to one embodiment, the material is retained in the form until it reaches a shape-holding state, which may occur almost immediately when then the application of consolidation energy ceases in some embodiments.

The adjustable form 110 is removed once the material is sufficiently stable to maintain a shape without support of the form. The cavity shape of the forming chamber is reconfigured if necessary for a next portion of the structure, the head 102 moved to the next position (before, after, or during reconfiguring the adjustable form 110 for that position), and material dispensed at the new dispense location. By repeating this process of continually adjusting the forming chamber, moving the head 102, and dispensing additional material, and consolidating the material as needed, an entire object, such as a precast object, is made.

In some embodiments, the object is formed by building the object layer-by-layer. For example, after completing a layer of the object, the additive manufacturing system 100 may form a subsequent layer on top of the preceding layer, adding subsequent layers until the object has reached the required height. At the time that the last layer is being formed the additive manufacturing system 100 may use elements of the adjustable form to scrape the top surface of the structure thus leveling or screeding the surface.

The additive manufacturing system 100 can pause the forming process so that a human or another machine may interact with the structure being formed. The interaction may be for the purpose of testing or inspecting the structure, correction of errors, or performing additional work, such as placing rebar, lintels, conduit, penetration sleeves, lifting embeds, or adding other components; or making modifications that cannot be created via the 3D casting system, such as adding date stamps or decorative features.

As mentioned, the positions of the head 102, the configuration of the adjustable form 110, the activation of consolidation element 114, and the dispensing of material are controlled by a program running on the control system 108 in some embodiments. In other embodiments, one or more of the positions of the head 102, the configuration of the adjustable form 110, the activation of consolidation element 114 or the dispensing of material may be controlled by manual controls. Further, in some embodiments, consolidation may be performed by human laborers or additional automated equipment in addition to or as alternative to using a consolidation element 114.

In one embodiment, human laborers, or additional automated equipment position steel reinforcement bar (rebar) interleaved and in coordination with the automatic steps taken by the additive manufacturing system 100. In addition, or in the alternative, the head 102 is augmented with a mechanism to insert rebar or other reinforcing material automatically. In one embodiment, an appropriate dosage of steel fibers can be used to provide tensile strength in lieu of steel reinforcing bar (rebar).

Manufacturing system 100 is adapted to dispense concrete or other cementitious materials in some embodiments. As will be appreciated, concrete generally comprises a mixture of cement, aggregates, and water. Concrete may also include additional materials or admixtures. The concrete is selected to have desirable working properties, which can be controlled using, for example, admixtures so that the concrete exhibits desired stiffness (ability of the concrete to hold its own shape) and strength (ability to hold its shape when external force is applied, such as by stacking additional concrete on top of it), while retaining the capability to be consolidated to allow the concrete to mechanically intermix with adjacent concrete.

The working properties of concrete can be controlled using, for example, various admixtures, such as water reducing (superplasticizers) admixtures, set-retarders, accelerators, air entraining agents or other admixtures. The present method can work with a wide variety of concretes and other castable materials. According to one embodiment, admixtures can be added just before the concrete is dispensed. “Part 645 Construction Inspection National Engineering Handbook,” United States Department of Agriculture, 210-VI-NEH, Amend. 81, April 2017, which is fully incorporated by reference herein describes, for example, that admixtures can be delivered by a separate hose and added to the concrete at a nozzle.

Furthermore, “Volume II: Investigation On Thixotropy Of Vibration-Free Concrete Mixtures Intended For Rapid Pavement Construction, by Dimitri Feys and Piyush Rajendra Lunkad, published by Research on Concrete Applications for Sustainable Transportation (RE-CAST), Publication No. RECAST UTC #00055304, is incorporated by reference herein in its entirety. The publication describes that admixtures can be added just before the material passes through a nozzle. In some embodiments, a high- or medium-slump concrete is used and then admixtures are introduced just before the concrete is dispensed to adjust the working properties of the concrete.

In preferred embodiments, the material used has a rheology such that it liquifies essentially immediately or otherwise quickly when consolidation energy is applied and stiffens essentially immediately or otherwise quickly upon the cessation of the application of the consolidation energy. Further, the material has a curing profile so that it begins to set immediately or almost immediately upon being dispensed. More particularly, in some embodiments, the material has a rheology so that it becomes stiff and non-deforming enough to hold its shape upon being dispensed into the forming chamber but has sufficient shear thinning properties such that it liquifies as soon as consolidation energy is applied and returns to a shape-holding state upon the cessation of the application of consolidation energy. In one embodiment, the material exhibits properties of a zero-slump or no-slump state upon being dispensed and returns to that state upon cessation of the application of consolidation energy.

As discussed, the working properties of concrete can be controlled using admixtures. In one embodiment, a viscosity modifying admixture is used, and more particularly, an admixture that promotes shear thinning. In the absence of consolidation energy, the admixture-modified concrete forms a paste or gel-like substance. However, when consolidation energy is applied, such as through vibration or other forms of consolidation, the concrete liquifies quickly—for example, almost instantaneously—through the phenomena known as shear thinning. Furthermore, a second admixture can be used so that the concrete begins to set quickly so that it rapidly gains an at rest shear strength to support the weight from subsequent layers stacked atop it, while remaining workable—in particular, retaining the capability to be reliquefied and mechanically intermixed with the subsequent layer—when the immediately subsequent layer is formed atop it.

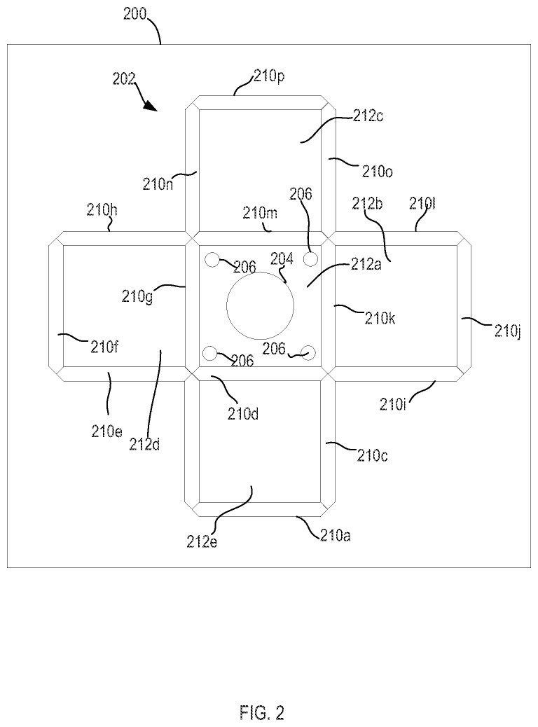

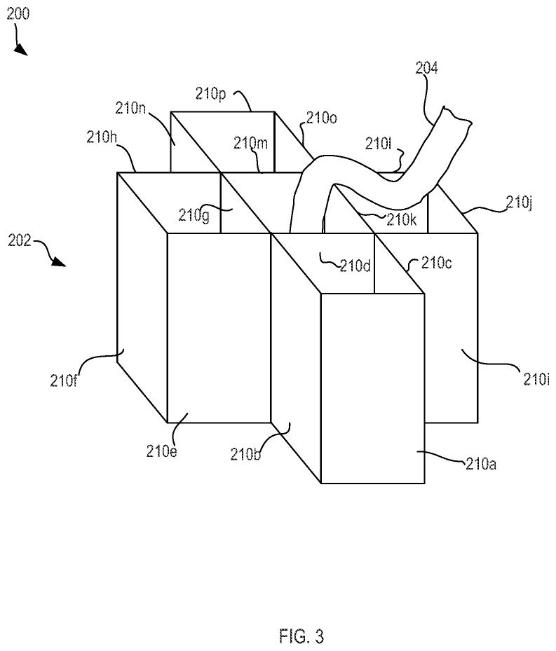

FIG. 2 is a diagrammatic representation of a top view of one embodiment of a head 200, which is one embodiment of head 102. FIG. 3 is a diagrammatic representation of an orthographic three-dimensional view of one embodiment of head 200. In the embodiment of FIG. 2, the head 200 comprises an adjustable form 202, a material delivery hose 204 to deliver material from a source (e.g., material delivery system 106 of FIG. 1) to adjustable form 202, and a consolidation element 206. In this embodiment, the material delivery hose 204 is placed at the center of the adjustable form 202. The consolidation element 206 comprises a set of vibrators disposed about the material delivery hose 204. The vibrators can be raised, lowered, and activated as needed. In addition, or in the alternative, head 200 may include a form vibrator to vibrate the adjustable form 202. In some embodiments, the form vibrator comprises a plurality of discrete form vibrators to vibrate any combination of the form sections.

The adjustable form 202 comprises a plurality of form sections including form section 210a, form section 210b, form section 210c, form section 210d, form section 210e, form section 210f, form section 210g, form section 210h, form section 210i, form section 210j, form section 210k, form section 210l, form section 210m, form section 210n, form section 210o, and form section 210p. While illustrated as relatively thin wall segments, the form sections may have a variety of shapes, sizes and mechanisms of movement. Examples include, but are not limited to, blades, slats, blocks, or other components that can be used to define a forming chamber.

The form sections may be selectively actuated to form a forming chamber having a desired shape as defined by the lowered form sections. In the illustrated embodiments, the forming chamber comprises a central chamber portion 212a, which can be fluidly connected to zero or more additional chamber portions (e.g., chamber portion 212b, chamber portion 212c, chamber portion 212d, chamber portion 212e) zero or more of chamber portion 212b, chamber portion 212c, chamber portion 212d, or chamber portion 212e. Material is dispensed via material delivery hose 204 into chamber portion 212a and may flow to other sections of the forming chamber. In some embodiments, the material delivery hose 204 does not protrude into the forming chamber. In other embodiments, the material delivery hose 204 partially protrudes into the forming chamber. According to one embodiment, the vibrators of the consolidation element 114 are positioned and controlled so the vibration influences the material dispensed in chamber portion 212a. The vibrations may also extend at least partially into adjoining chamber portions.

According to one embodiment, the form sections are configured to create a forming chamber for a first location. The head 200 is positioned at a position corresponding to the first location and material is dispensed and consolidated at the first location. If the next dispense location requires a different configuration of the adjustable form, any form sections that are lowered in the current configuration but raised in the next configuration are raised prior to moving head 200 to the next position. In other embodiments, all the form sections are raised. The head 200 then moves to position the adjustable form for the next dispense location. Any raised form sections that need to be lowered for the new location are lowered to create the forming chamber for that location. Additional material is dispensed and consolidated at that location. This process can be repeated to build an object.

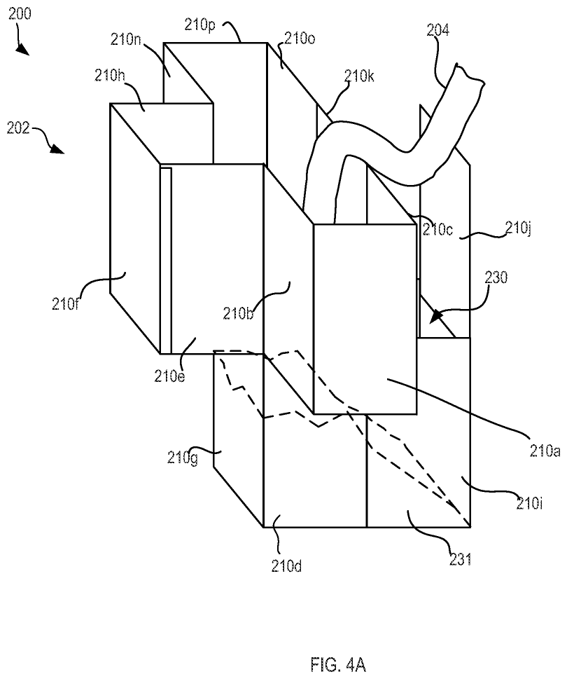

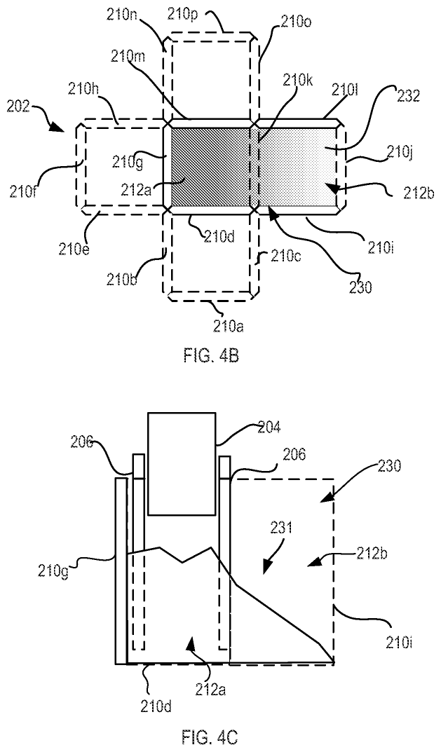

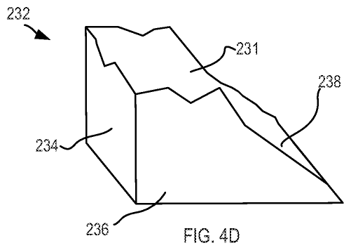

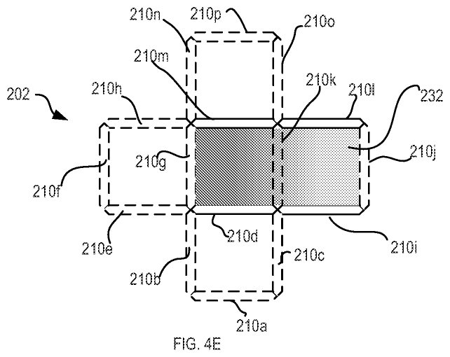

FIG. 4A through FIG. 14 illustrate an example of an additive process using the adjustable form 202 to form a portion 232 of an object being created. In the example of FIG. 4A through FIG. 13B, the head is positioned at various locations (a first location, a second location, etc.) so that material can be dispensed at those locations. The first location, second location, etc. are provided by way of explanation. As will be appreciated, the locations at which material is dispensed and the order in which material is dispensed will vary depending on the object being built and the build order used.

FIG. 4A is a diagrammatic representation of one embodiment of the head 200 with the adjustable form 202 in a first configuration for a first example location, FIG. 4B is a diagrammatic representation of a top view of one embodiment of the adjustable form 202 at the first location, FIG. 4C is a diagrammatic representation of one embodiment of consolidating the dispensed material, FIG. 4D is a diagrammatic representation of one embodiment of the portion of the object formed by dispensing material at the first location, and FIG. 4E is a diagrammatic representation of one embodiment of the adjustable form configured for movement to an example second location.

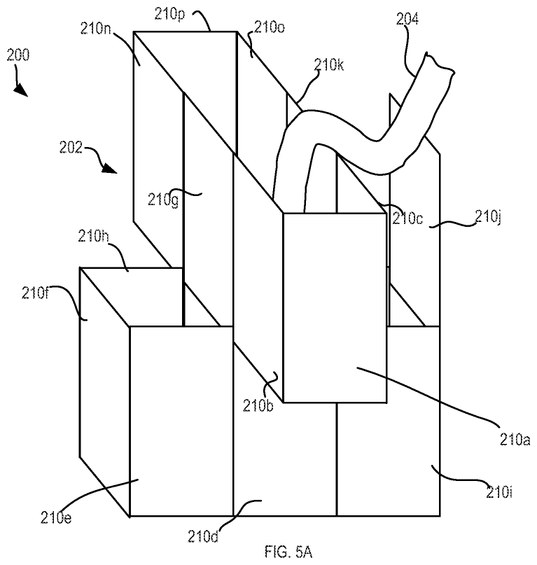

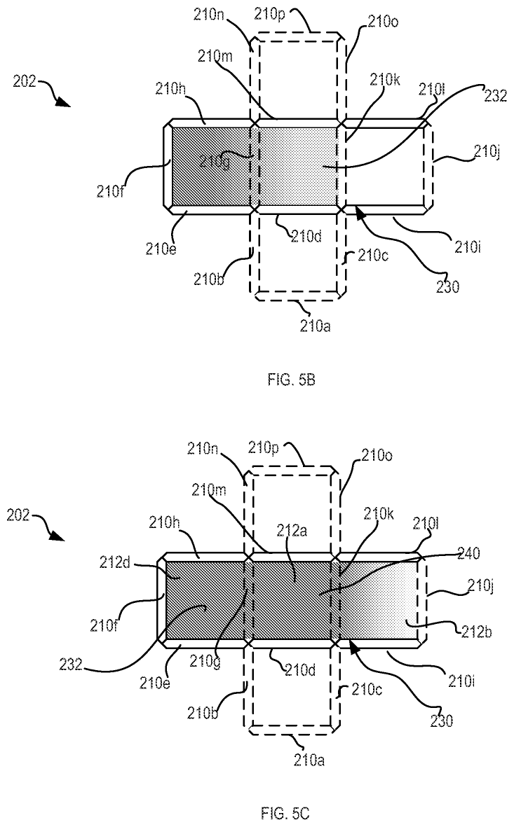

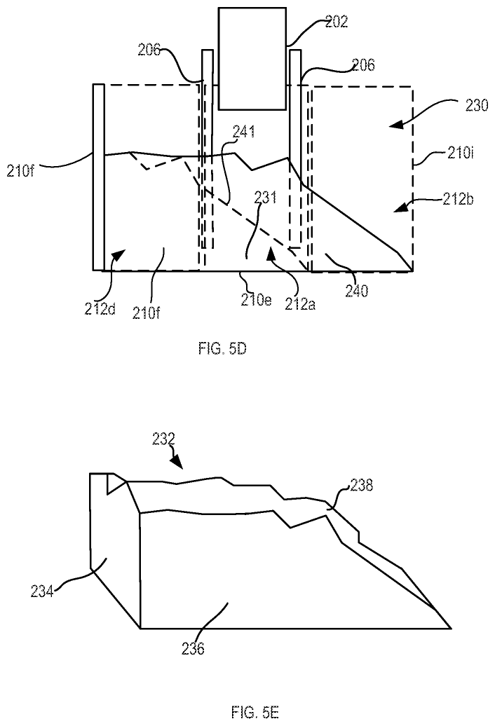

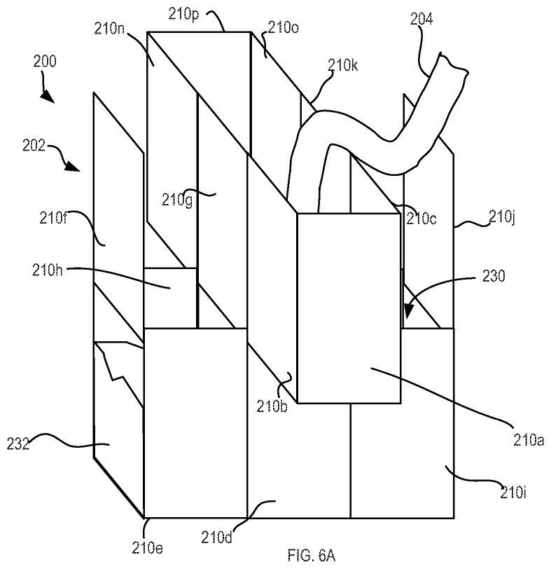

FIG. 5A is a diagrammatic representation of one embodiment of the adjustable form 202 in another configuration, FIG. 5B is a diagrammatic representation of a top view of one embodiment of the adjustable form 202 at the second location, FIG. 5C is a diagrammatic representation of a top view of one embodiment of the adjustable form 202 with additional material having been dispensed at the second location, FIG. 5D is a diagrammatic representation of one embodiment of consolidating material at the second location, and FIG. 5F is a diagrammatic representation of one embodiment of the portion of the object being created having been extended.

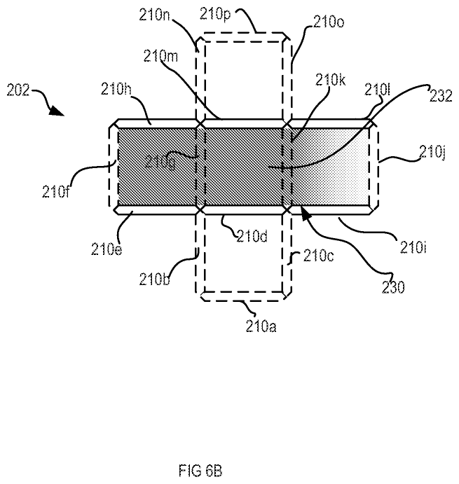

FIG. 6A is a diagrammatic representation of one embodiment of adjustable form 202 configured in yet another configuration for movement to a third location and FIG. 6B is a diagrammatic representation of a top view of one embodiment of the head 200 with the adjustable form 202.

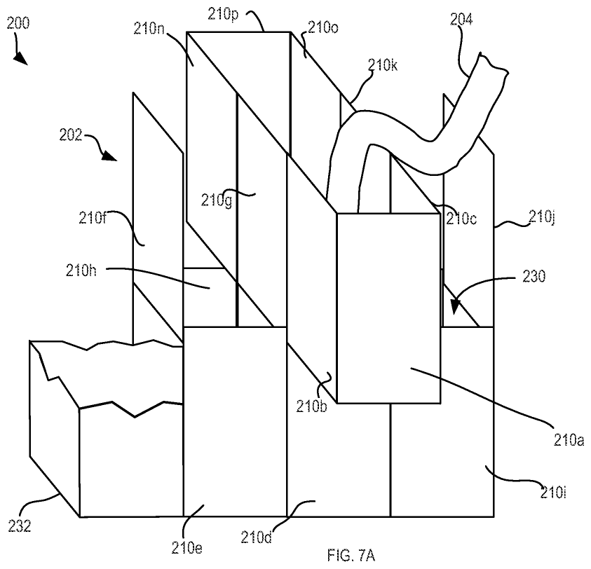

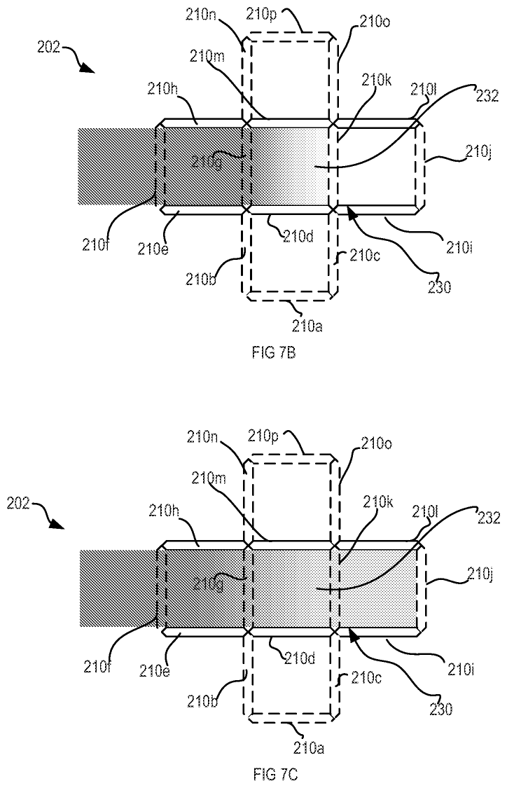

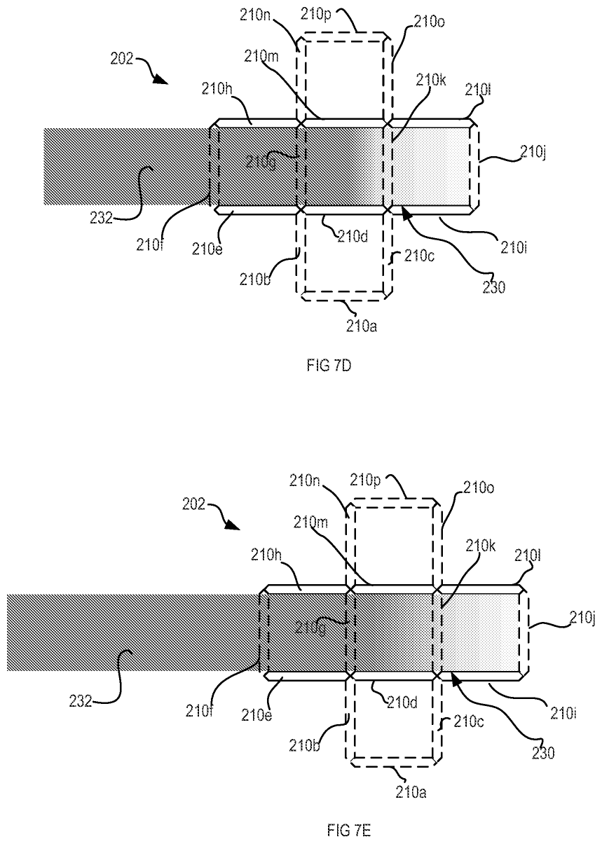

FIG. 7A is a diagrammatic representation of one embodiment of the head 200 with the adjustable form 202 at the third location, FIG. 7B is a diagrammatic representation of a top view of one embodiment of the adjustable form 202 at the third location, FIG. 7C is a diagrammatic representation of a top view of one embodiment of the adjustable form 202 at the third location with additional material having been dispensed to extend the portion of the object being created, FIG. 7D is a diagrammatic representation of a top view of one embodiment of the adjustable form 202 at a fourth example location with additional material having been dispensed to extend the portion of the object being created, FIG. 7E is a diagrammatic representation of a top view of one embodiment of the adjustable form 202 at a fifth example location with additional material having been dispensed to extend the portion of the object being created.

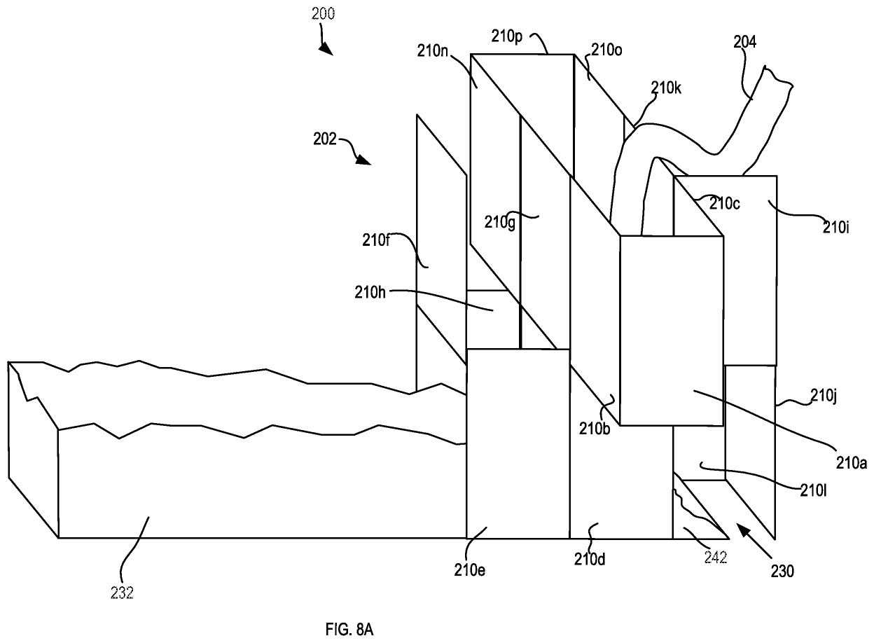

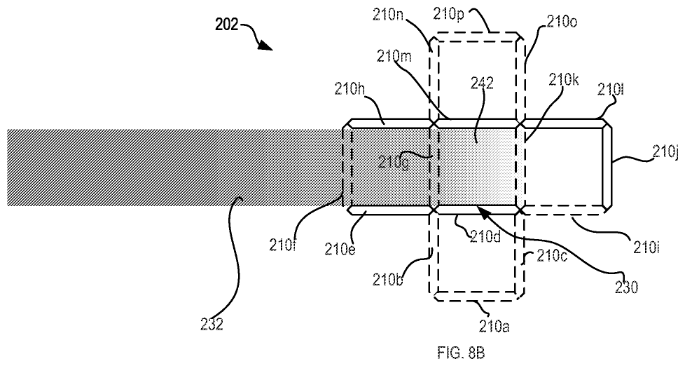

FIG. 8A is a diagrammatic representation of one embodiment of the head 200 with the adjustable form 202 in yet another configuration and at a sixth example location and FIG. 8B is a diagrammatic representation of a top view of one embodiment of the adjustable form 202 with material dispensed at the sixth location to extend the portion of the object being created.

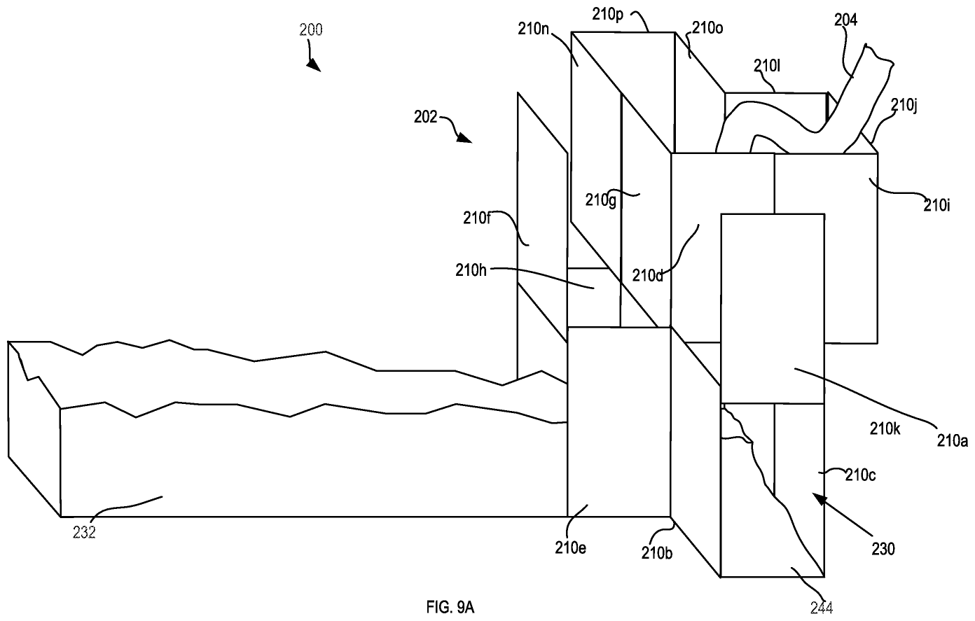

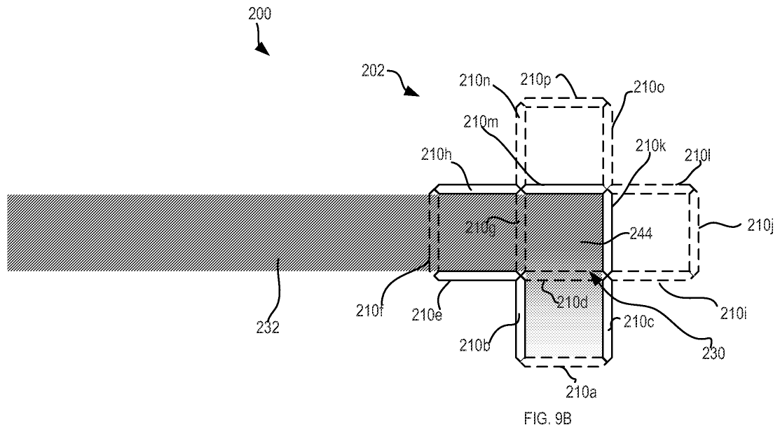

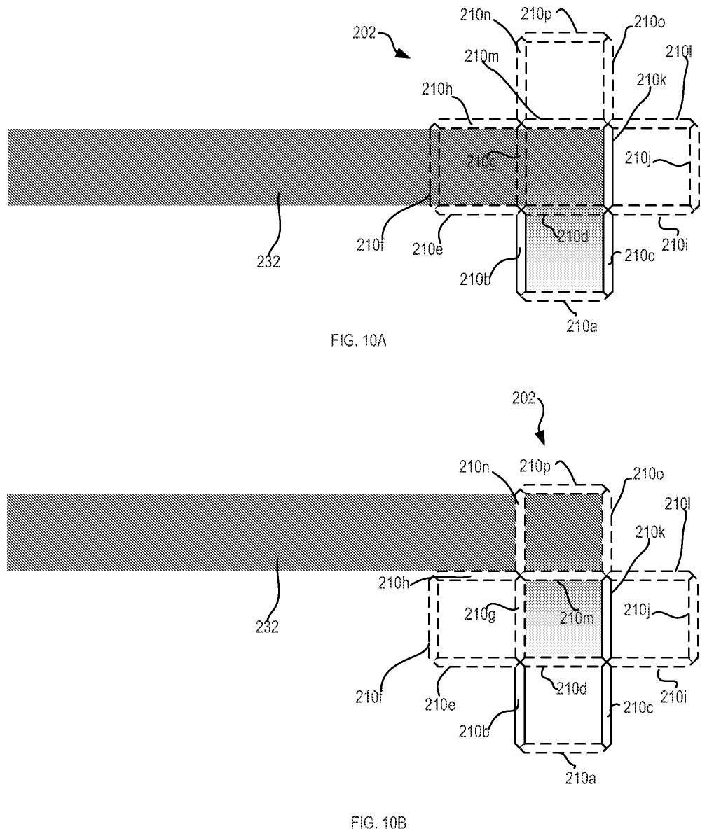

FIG. 9A is a diagrammatic representation of one embodiment of the adjustable form 202 in another configuration and at a seventh example location and FIG. 9B is a diagrammatic representation of a top view of one embodiment of the adjustable form 202 with material dispensed at the seventh location to extend the portion of the object being created.

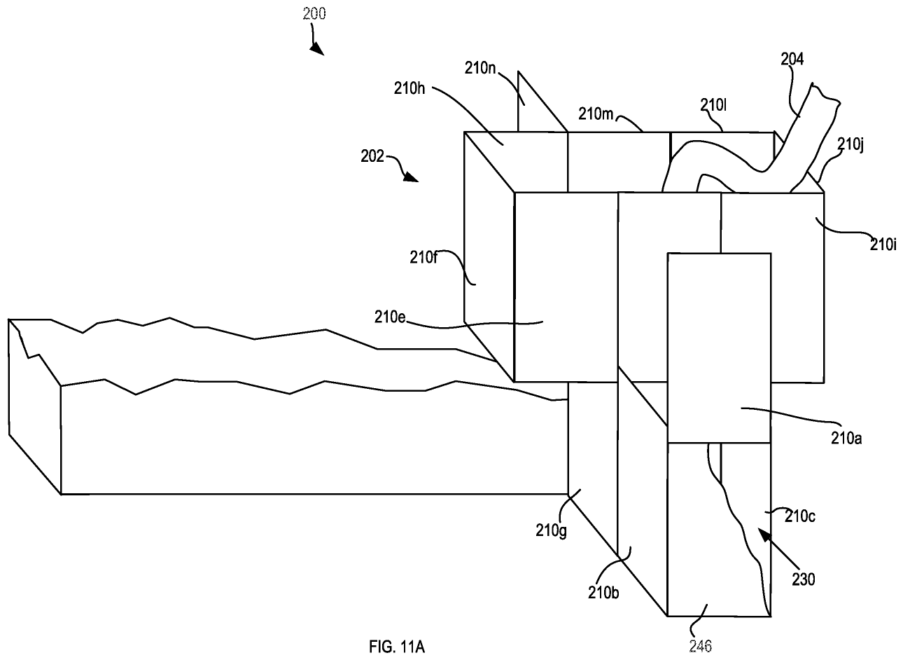

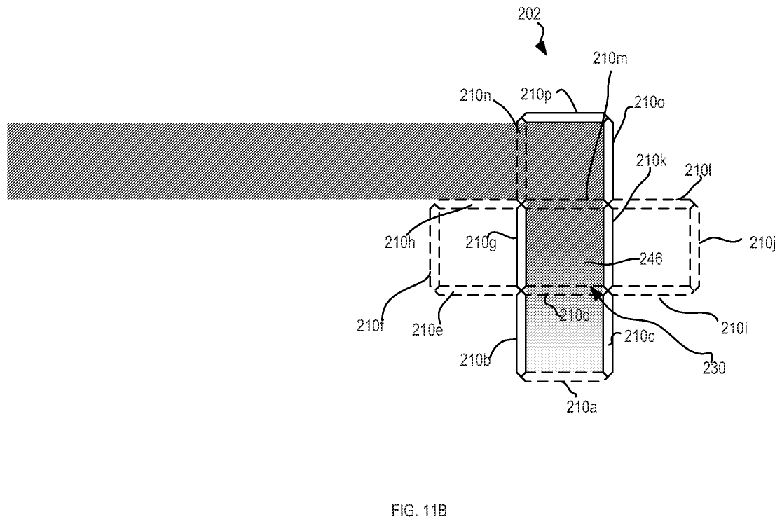

FIG. 10A is a diagrammatic representation of a top view of one embodiment of the adjustable form 202 in another configuration to allow movement to an eighth example location and FIG. 10B is a diagrammatic representation of a top view of one embodiment of the adjustable form 202.

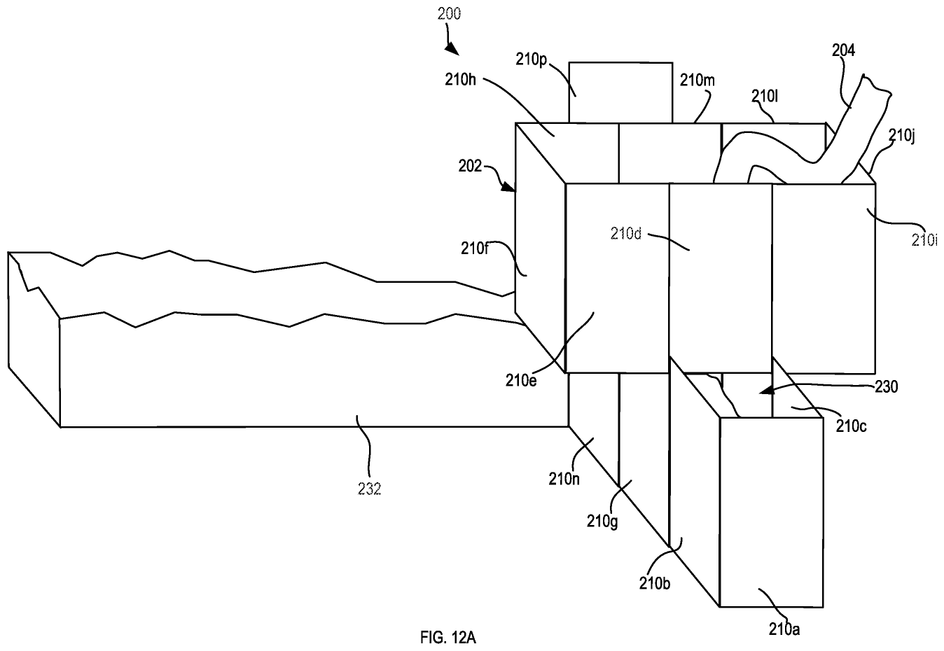

FIG. 11A is a diagrammatic representation of one embodiment of the head 200 with the adjustable form 202 in another configuration and at an eighth example location and FIG. 11B is a diagrammatic representation of a top view of one embodiment of the adjustable form 202 with material dispensed at the eighth location to extend the portion 232 of the object being created.

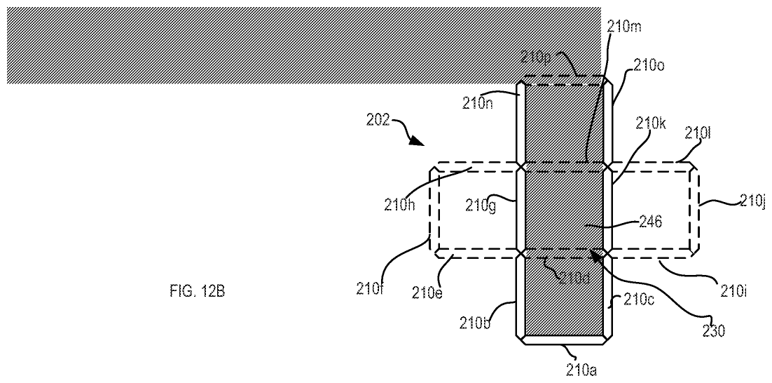

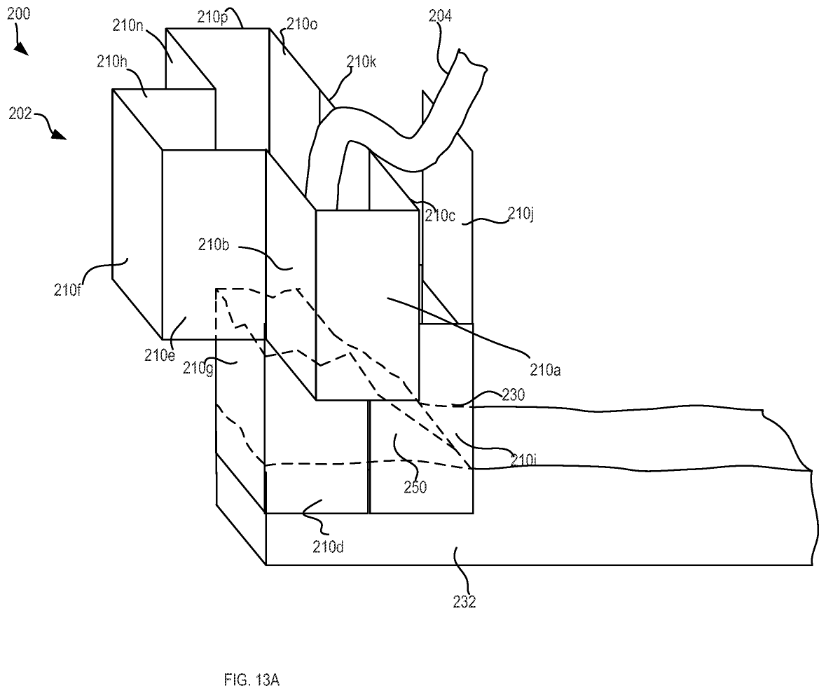

FIG. 12A is a diagrammatic representation of one embodiment of the head 200 with the adjustable form 202 in yet another configuration and at a ninth location and FIG. 12B is a diagrammatic representation of a top view of one embodiment of the adjustable form 202 with material dispensed at the ninth location to extend the portion 232 of the object being created.

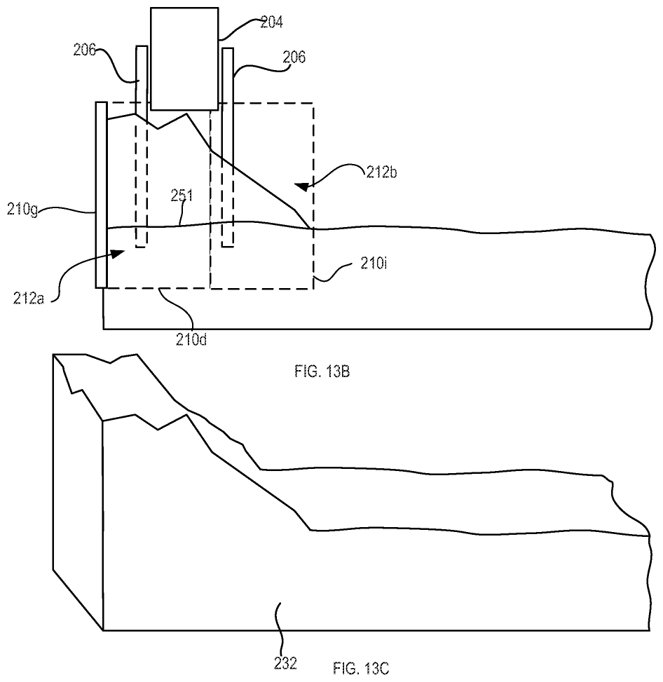

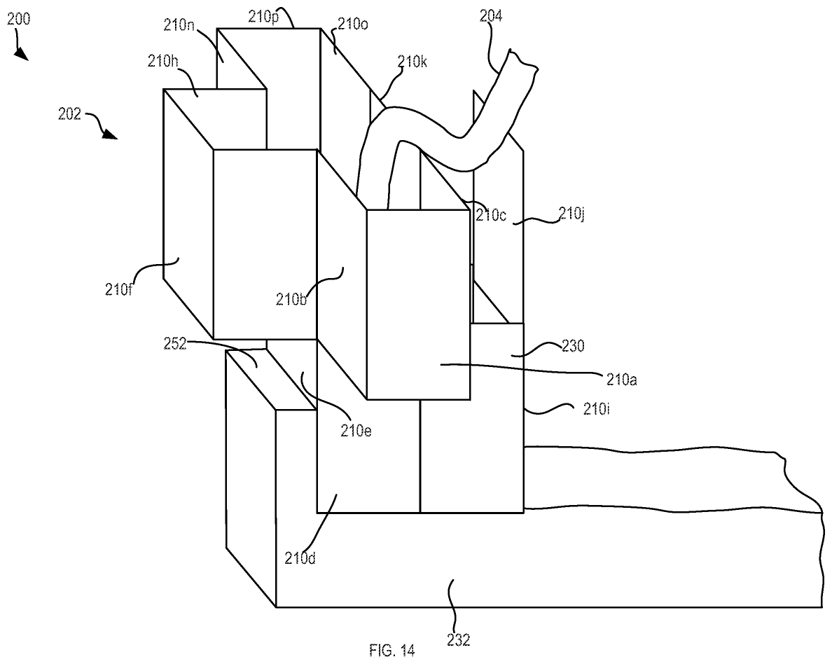

FIG. 13A is a diagrammatic representation of one embodiment of the head 200 dispensing new material into the adjustable form 202 at a tenth location, which is above the first location, to vertically extend the portion 232 of the object being created, FIG. 13B is a diagrammatic representation of one embodiment of consolidating the dispensed material and FIG. 13C is a diagrammatic representation of one embodiment of a subsection of the portion 232 of the object being created. FIG. 14 illustrates one embodiment of the adjustable form 202 moving from the tenth location to an eleventh location, which is above the second location. In FIG. 4B, FIG. 4E, FIG. 5B, FIG. 5C, FIG. 6B, FIG. 7A, FIG. 7B, FIG. 7C, FIG. 7D, FIG. 7E, FIG. 8B, FIG. 9B, and FIG. 10B, the lowered form sections illustrated in solid lines and the retracted form sections indicated in dashed lines.

During the process of forming an object, the shape and position of the casting form are adjusted based, for example, on instructions defined by a program run at the control system 108 (FIG. 1). Turning to FIG. 4A and FIG. 4B, one embodiment of using the adjustable form 202 to form material into a portion of an object being created is provided. The adjustable form 202 is controlled to have a first configuration for a first location. More particularly, the form sections are actuated to create a forming chamber 230 having a desired shape for the first location. Further, the adjustable form 202 is positioned at the first location.

In this example, form section 210g, form section 210m, form section 210l, form section 210i, and form section 210d are lowered to define the forming chamber 230, which is open at one end, and the other form sections are retracted (raised). The forming chamber 230 thus includes chamber portion 212a and chamber portion 212b. Material is delivered via the material delivery hose 204 to the adjustable form 202 and dispensed into the forming chamber 230 until it reaches a predetermined volume. Thus, material 231, which is a first portion of the material used to create the object, is dispensed at the first example location.

The material 231 may have a rheology so that it begins to set immediately or almost immediately upon being dispensed and so that it liquifies essentially immediately or otherwise quickly when consolidation energy is applied and stiffens essentially immediately or otherwise quickly upon the cessation of the application of the consolidation energy. More particularly, the material may have a rheology so that it exhibits shape-holding properties upon being dispensed into the forming chamber 230 but has sufficient shear thinning properties such that it liquifies as soon as consolidation energy is applied, and returns to a shape-holding state upon the cessation of the application of consolidation energy. As such, material 231 may accumulate under the opening of material delivery hose 204 in a generally cone or “volcano” shape and does not flow or only slightly flows to the walls of chamber portion 212a. According to one embodiment, the material 231 is consolidated so that it liquifies and flows to the walls of chamber portion 212a and at least partially into chamber portion 212b.

As illustrated in FIG. 4C, the material 231 in the forming chamber 230 may be consolidated as needed (form sections 210i and 210d are made transparent). The consolidation element 206—for example, one or more vibrators—is lowered into the material 231 in the forming chamber 230 and activated to impart energy. In another embodiment, the adjustable form 202 (or individual sections thereof) is vibrated to consolidate the material in the forming chamber 230. Consolidation causes the material 231 to liquify, allowing it to flow against the walls of the forming chamber 230 at chamber portion 212a. Consolidation may also cause the material to flow at least partially into chamber portion 212b. While illustrated as flowing the entire length of chamber portion 212b, the material is consolidated in some embodiments such that it only flows halfway or less into any chamber portions of the forming chamber 230 adjacent to the central chamber portion 212a. With consolidation performed, the consolidation element 114 is retracted.

The material is allowed to stiffen sufficiently so that it maintains its shape when the adjustable form 202 is removed. As discussed above, in some embodiments the material has a rheology so that it stiffens to a shape-holding state almost immediately upon cessation of the consolidation energy. The material 231 creates a formed portion 232 of an object being created.

As will be appreciated then, the material 231 flows to take on a shape that is at least partially defined by the forming chamber. In other cases, the dispensed material takes on a shape that is not defined by the forming chamber, for example when the material is dispensed at a location at which the newly dispensed material is surrounded on all sides by previously dispensed material. The material that comes up against the surfaces of the form sections that define the forming chamber 230 generally take on the surface shape, which may be smooth in some embodiments. Thus, as illustrated in FIG. 4D, the formed portion 232 includes finished surfaces that are formed by the form sections (finished surface 234 and finished surface 236 are visible). The formed portion 232 also includes a working surface 238. The head 200 can be moved to reposition the adjustable form 202, the adjustable form 202 may be reconfigured if needed, and additional material dispensed, and consolidated with the consolidation element 206. The working surface 238 may take on the shape of a finished surface as it flows forward, and additional material accumulates on top of it.

As discussed, the adjustable form 202 can be moved to a new position. Any form sections that are lowered in the first configuration of FIG. 4A and FIG. 4B that need to be raised for the second dispense location are raised and head 200 moves to the new position. In the example of FIG. 4E, the adjustable form 202 is reconfigured to a second configuration by raising form section 210g and the head advances to the next position. At the new dispense location, any form sections that need to be lowered are lowered. In the illustrated embodiment of FIG. 5A and FIG. 5B, the adjustable form 202 is reconfigured to a third configuration (FIG. 5A and FIG. 5B) corresponding to the second location. In this example, form section 210f, form section 210e and form section 210f are lowered (compared to the configuration in FIG. 4E). Thus, form section 210f, form section 210e, form section 210d, form section 210i, form section 210l, form section 210m and form section 210h define the forming chamber 230 and the other form sections are retracted.

At this position, the head 200 dispenses additional material 240 (FIG. 5C, FIG. 5D) until it reaches a predetermined volume. Material 240 is thus a second portion of the material used to form the object being created. According to one embodiment, the head 200 dispenses the additional material 240 at chamber portion 212a on top of the precedingly dispensed material or in a position that allows the additional material 240 to flow onto the previously dispensed material. In the example of FIG. 5C, the new material 240 is dispensed at chamber portion 212a by the head 200. Thus, in some embodiments, the head 200 dispenses the new material 240 partially on top of the previously dispensed material 231, which has been allowed to stiffen to the point that it can hold its form without the adjustable form 202. As illustrated in FIG. 5D, the material in forming chamber 230 may be consolidated as needed. For example, the consolidation element 206 is lowered into the newly dispensed material 240 in the forming chamber 230. In some embodiments, the consolidation element 206 extends into the previously dispensed material 231 below the newly dispensed material 240. In another embodiment, the adjustable form 202 is vibrated to consolidate the material in the forming chamber 230.

The consolidation element 206—for example, one or more vibrators—is lowered into the material in the forming chamber 230 and activated to impart energy. Consolidation causes the material 240 to liquify, allowing it to flow against the walls of the forming chamber 230 at chamber portion 212a. Consolidation of material in the forming chamber may also cause the material to flow at least partially into chamber portion 212b and chamber portion 212d. While illustrated as flowing the entire length of chamber portion 212b, the material is consolidated in some embodiments such that it only flows halfway or less into any chamber portions of the forming chamber 230 adjacent to the central chamber portion 212a.

Additionally, consolidation of the material in the forming chamber 230 can include consolidating the previously dispensed material 231 below the newly dispensed material 240 and in particular consolidating at least the portion of the previously dispensed material 231 proximate to the interface 241 between the newly dispensed material 240 and the previously dispensed material 231 so that interface 241 liquifies to allow the newly dispensed material 240 and previously dispensed material 231 to mechanically intermix. With consolidation performed, the consolidation element 206 is retracted. The material is allowed to stiffen sufficiently so that it maintains its shape when the adjustable form 202 is removed, which may occur immediately upon cessation of the application of the consolidation energy in some embodiments.

Turning to FIG. 5E, the formed portion 232 is extended by material 240 and has finished surfaces (finished surface 234 and finished surface 236 are shown) as defined by the forming chamber 230 and a working surface 238. The formed portion 232 is extended in a manner that does not result in cold seams or visible seams between the previously dispensed material 231 and the newly dispensed material 240. Thus, the new material 240 and the previously dispensed material 231 form a seamless and contiguous structure.

More particularly, by consolidating the newly dispensed material 240 and the previously dispensed material 231, the matrix of material components—for example, often sand, coarse aggregate, and cement, in the case of concrete—is evenly mixed and void-free within and across the newly dispensed material 240 and the previously dispensed material 231, thereby consolidating them together into one monolithic, contiguous, and joint free portion 232. As such, “cold joints” are avoided and a monolithic structure cast.

The adjustable form 202 is then moved to further extend the formed portion 232 of the object being created. In FIG. 6A and FIG. 6B, for example, the adjustable form 202 is reconfigured to a fourth configuration for movement to a third location by raising form section 210f. In this configuration, form section 210e, form section 210d, form section 210i, form section 210l, form section 210m and form section 210h define the forming chamber 230, and the remaining form sections are retracted. The adjustable form is advanced to the third location (FIG. 7A and FIG. 7B). Additional material is dispensed at the third location (FIG. 7C) and the material in the forming chamber consolidated as needed. This may include consolidating previously dispensed material adjacent to the newly dispensed material. In any event, as illustrated, the formed portion 232 is further extended with the additional material, which has a shape at least partially defined by the adjustable form 202 and the previously dispensed material. The newly dispensed material can be allowed to stiffen until it is stable enough to hold its shape without the adjustable form 202. As discussed above, this may occur almost immediately upon cessation of consolidation energy in some embodiments.

The head 200 can continue to move and deposit material at each location according to the design of the object being created. For example, the adjustable form 202 can be moved to a fourth example location (FIG. 7D) and a fifth example location (FIG. 7E). Additional material is dispensed at each location, consolidated, and allowed to stiffen as needed at the fourth location and fifth location to further extend the formed portion 232 of the object being created.

Some embodiments of an adjustable form 202 can be configured to form corners. In FIG. 8A and FIG. 8B, for example, the adjustable form 202 is reconfigured into a fifth configuration (not shown) by raising form section 210i and moved to a sixth location. Adjustable form is reconfigured to a sixth configuration to facilitate a 90-degree bend by lowering form section 210j. In the sixth configuration, form section 210d, form section 210e, form section 210h, form section 210m, form section 210l, and form section 210j are lowered to define the forming chamber 230 and the remaining form sections raised. Additional material 242 is dispensed into the forming chamber 230, consolidated, and allowed to stiffen as needed to extend the formed portion 232.

The adjustable form 202 is reconfigured into a seventh configuration (not shown) by raising form section 210d, form section 210j and form section 210l. The adjustable form 202 is moved to a seventh location. With reference to FIG. 9A and FIG. 9B, the adjustable form 202 is reconfigured to an eighth configuration by lowering form section 210c, form section 210b, and form section 210k. In the configuration of FIGS. 9A and 9B, form section 210h, form section 210m, form section 210k, form section 210c, form section 210b, and form section 210e define the forming chamber 230 and the other form sections are raised. Additional material 244 is dispensed into the forming chamber 230 until the material reaches a desired volume. The material in forming chamber 230 is consolidated so that it takes on a shape at least partially defined by forming chamber 230 (and the previously dispensed material) and mechanically intermixes with the previously dispensed material.

The adjustable form 202 is reconfigured into a ninth configuration (FIG. 10A) by raising form section 210h, form section 210k, and form section 210m. The adjustable form 202 is moved to an eighth location (FIG. 10B).

The adjustable form 202 is reconfigured to a tenth configuration at the eighth location (FIG. 11A and FIG. 11B). More particularly, form section 210g and form section 210o are lowered such that form section 210p, form section 210o, form section 210k, form section 210c, and form section 210b, and form section 210g define the forming chamber 230 and the other form sections remain retracted. Additional material 246 is dispensed at the eighth location. The material in forming chamber 230 is consolidated and allowed to stiffen as needed to extend the formed portion 232.

The adjustable form 202 is reconfigured to an eleventh configuration for movement to a ninth location. In particular, form section 210p is raised. The adjustable form is moved to the ninth location and reconfigured to a twelfth configuration suitable for the ninth location. For example, form section 210n and form section 210a are lowered. FIG. 12A is a diagrammatic representation of one embodiment of the adjustable form 202 in a twelfth configuration and at a ninth location and FIG. 12B is a diagrammatic representation of a top view of one embodiment of the adjustable form 202 according to the twelfth configuration with material dispensed at the ninth location to extend the portion 232 of the object being created. In this example, form section 2100, form section 210k, form section 210c, and form section 210b, form section 210g and form section 210n define the forming chamber 230 and the other form sections remain retracted. Material is delivered via the material delivery hose 204 and dispensed into the forming chamber 230 until it reaches a predetermined volume. The material in forming chamber 230 is consolidated and allowed to stiffen as needed to extend the formed portion 232.

In addition, or in the alternative, to horizontally extending an object being created, embodiments can vertically extend the material. For example, after completing a layer of the object being built, the material casting system may form a subsequent layer on top of the preceding layer, adding subsequent layers until the structure has reached the required height. In general, the previous layer is allowed to set sufficiently to support the subsequently stacked layer while still remaining workable so that the layers can be consolidated together.

With reference to FIG. 13A, the adjustable form 202 is positioned at a tenth position, which is above the first position of FIG. 4A, to begin a second layer. The adjustable form 202 is configured for forming material at the tenth position. In the illustrated embodiment, the adjustable form 202 is configured in the first configuration (see, FIG. 4A and FIG. 4B) in which form section 210g, form section 210m, form section 210l, form section 210i, and form section 210d are lowered to define the forming chamber 230 and the remaining form sections are raised. According to one embodiment, the adjustable form 202 is positioned so that the lower ends of form section 210g, form section 210m, form section 210l, form section 210i, and form section 210d extend below the top of the previous layer.

Material 250 is delivered via the material delivery hose 204 to the forming chamber and dispensed until it reaches a predetermined volume. As illustrated, the material delivery hose deposits the additional material 250 on top of the previously formed portion 232 of the object being created, which is vertically adjacent to the location at which additional material 250 is dispensed.

In the example of FIG. 13A, the head 200 is positioned so that the ends of the adjustable form 202 extend below the top surface of the preceding layer. This can allow the top surface of the preceding layer to be reliquefied and mechanically intermixed with the current layer, all while being held within the extended adjustable form.

Turning to FIG. 13B, the material in forming chamber 230 may be consolidated as needed. For example, the consolidation element 206 can be lowered into the newly dispensed material 250 in the forming chamber 230. In some embodiments, the consolidation element 206 extends into the previously dispensed material of the layer below. The consolidation element 206 is activated to impart energy and consolidate the newly dispensed material 250. With consolidation performed, the consolidation element 114 is retracted. In another embodiment, the adjustable form 202 is vibrated to consolidate the material in the forming chamber 230.

Consolidation of the material in the forming chamber 230 can include consolidating the previously dispensed material below the newly dispensed material 250 and in particular consolidating the portion of the previously cast section proximate to the interface 251 between the newly dispensed material 250 and the previous dispensed material so that the interface 251 liquifies and the newly dispensed material and previously dispensed material mechanically intermix. With consolidation performed, the consolidation element 206 is retracted. The material is allowed to stiffen sufficiently so that it maintains its shape when the adjustable form 202 is removed.

By consolidating the newly dispensed material 250 and the previously dispensed material, the matrix of material components is evenly mixed and void-free within and across the newly dispensed material 250 and the previously dispensed material, thereby consolidating them together into one monolithic, contiguous, and joint free portion 232. As such, “cold joints” can be avoided, and a monolithic structure cast as illustrated in FIG. 13C.

At the time that the last layer is being formed, the adjustable form 202 or other element carried by the head may be used to scrape the top surface of the structure, thus leveling or screeding the surface. With reference to FIG. 14, the adjustable form 202 is moved from the tenth location to an eleventh location, which is above the second location (see, FIG. 5C). A form section, in this case the form section 210e, is set to a desired height to scrape the top surface of formed portion 232 as the adjustable form 202 moves from the tenth location to the eleventh location to create a smooth top surface 252.

By repeating this process of continually adjusting the forming chamber, moving the adjustable form 202, dispensing additional material, and consolidating the material, an entire object can be made. As will be appreciated, embodiments described herein may be used to build a variety of structures including, but not limited to basement walls, stem walls, finished walls, stairs, footings, piles, culverts, beams, doubleT, singleT, columns, septic tanks, distributions boxes, manholes and other structures.

The example process of FIG. 4A through FIG. 14 provides an example of consolidating material in the forming chamber 230 so that newly dispensed material mechanically intermixes with a previously cast, horizontally adjacent section (see e.g., FIG. 5C) and an example of consolidating material in the forming chamber 230 so that newly dispensed material mechanically intermixes with a previously cast, vertically adjacent section (see e.g., FIG. 13B). It will be appreciated that material may be dispensed at a location at which the newly dispensed material is horizontally and vertically adjacent to previously cast material. For example, when forming a current layer, the head 200 may dispense material at a location that is horizontally adjacent to previously cast material of the current layer and vertically adjacent to previously cast material of the previous layer. Consolidation of the material in the forming chamber 230 can be performed to ensure that the newly dispensed material sufficiently fills the forming chamber to take on a desired shape that is at least partially defined by the adjustable form and the previously dispensed material, is void free, and has mechanically intermixed with both the horizontally and vertically adjacent previously cast sections.

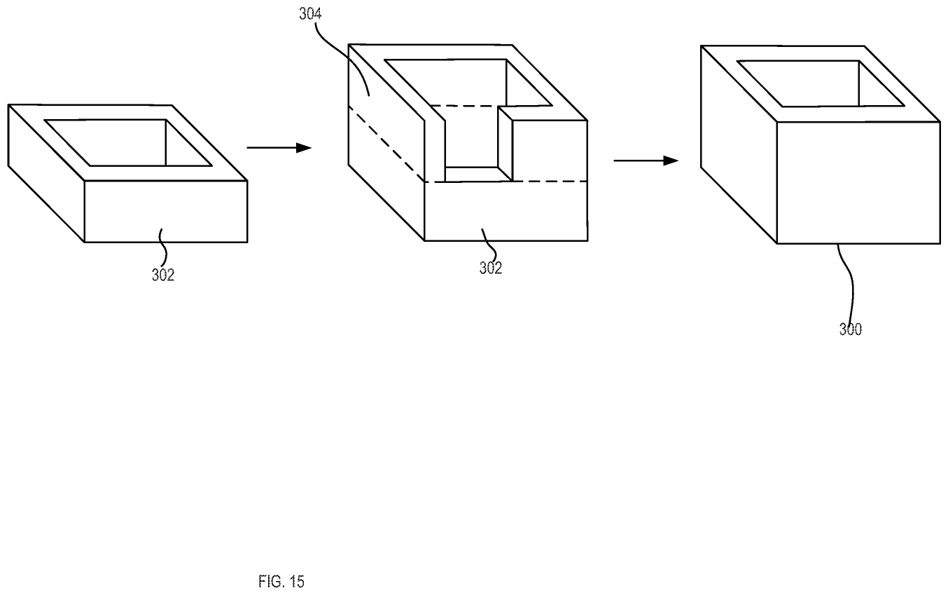

FIG. 15 illustrates one example of building an object 300 from a material such as concrete. In this example, a first layer 302 is built by dynamically configuring an adjustable form (e.g., the adjustable form 202), moving the adjustable form to a series of locations, dispensing material at each location, and consolidating the material. When the first layer 302 has set sufficiently to support a second layer 304 but is in a state in which it can still be consolidated, a second layer 304 is initiated. The head is positioned to dispense material on top of the first layer 302, and additional material is cast and consolidated with the first layer to form a second layer 304. The process is repeated until the final height of the object 300 is achieved. As illustrated, object 300 may be cast as a monolithic object without seams or cold joints between the layers.

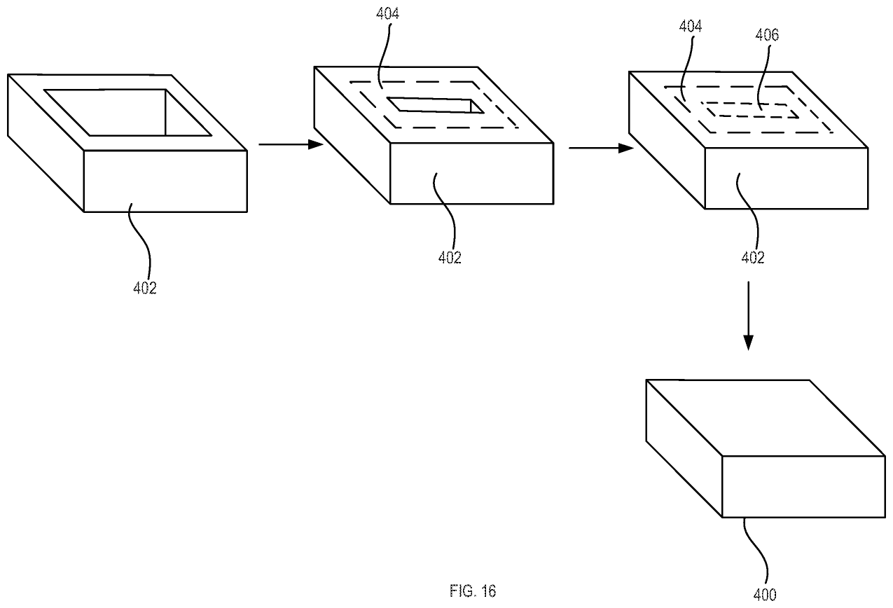

FIG. 16 illustrates another example of building an object 400 from a material such as concrete. In this example, a first portion 402 is built on a substrate by dynamically configuring an adjustable form (e.g., the adjustable form 202), moving the adjustable form to a series of locations, dispensing material at each location, and consolidating the material. When the first portion 402 is in a state that it can still be consolidated, the second portion 404 is initiated. The head is positioned to dispense material adjacent to first portion 402, and additional material is cast to form the second portion 404. The material is consolidated as the second portion 404 is formed so that first portion 402 and second portion 404 form a monolithic structure. With the second portion 404 in a state that it can still be consolidated a third portion 406 is initiated. The head is positioned to dispense material adjacent to second portion 404, and additional material is cast to form the third portion 406. The material is consolidated as third portion 406 is formed so that the third portion 406 forms a monolithic structure with the second portion 404. The process is repeated until a desired coverage is achieved. As illustrated, object 400 may be cast as a monolithic object without seams or cold joints between the adjacent portions.

FIG. 16 is provided by way of example and not limitation. Many different objects can be created, and many different build orders used.

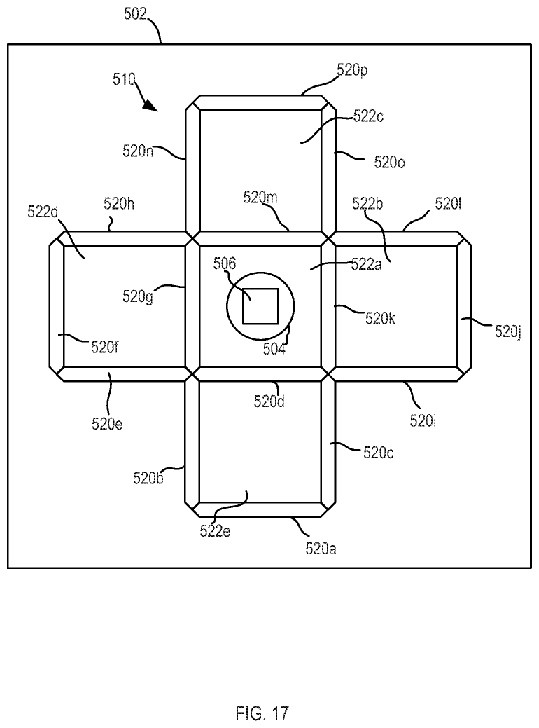

FIG. 17 is a diagrammatic representation of a bottom view of another embodiment of a head 502, which is another embodiment of head 102. In the embodiment of FIG. 17, head 502 comprises an adjustable form 510, a material delivery hose 504, and a consolidation element 506. In this embodiment, the material delivery hose 504 and consolidation element 506 are placed at the center of the adjustable form 510. The consolidation element 506 comprises a vibrator that can be raised, lowered, and activated as needed.

The adjustable form 510 comprises a plurality of form sections including form section 520a, form section 520b, form section 520c, form section 520d, form section 520e, form section 520f, form section 520g, form section 520h, form section 520i, form section 520j, form section 520k, form section 520l, form section 520m, form section 520n, form section 520o, and form section 520p. In one embodiment, the form sections are provided by a plurality of blade assemblies. The form sections may be selectively actuated to create a forming chamber that comprises chamber portion 522a into which material is dispensed and zero or more of chamber portion 522b, chamber portion 522c, chamber portion 522d, or chamber portion 522e into which material can flow. Adjustable form 510 can be configured similarly to adjustable form 202. According to one embodiment, the consolidation element 506 is controlled so the vibration influences the material dispensed in chamber portion 522a. The vibrations may also extend at least partially into adjoining chamber portions.

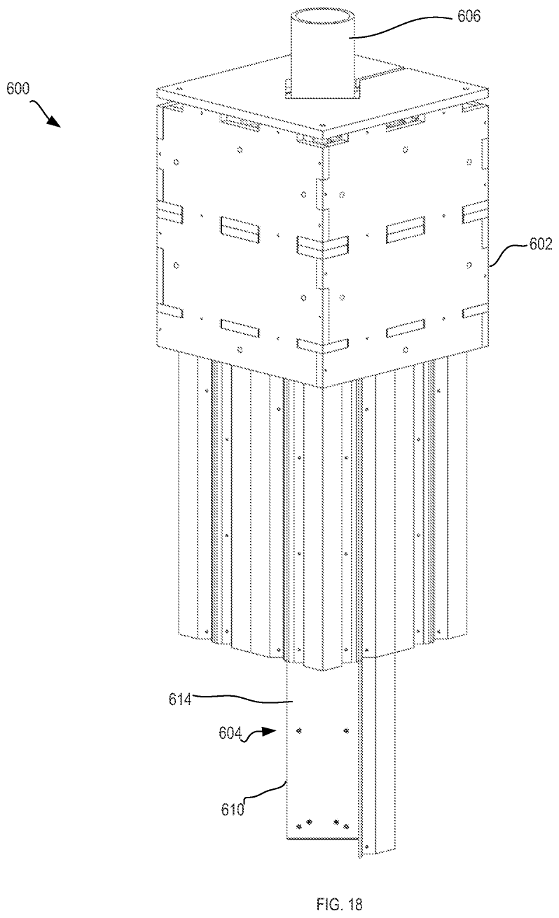

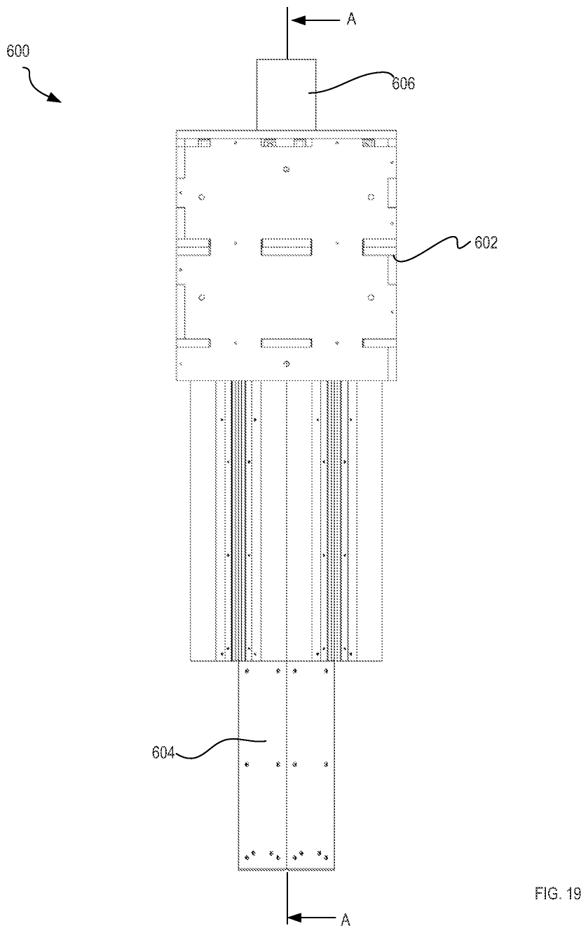

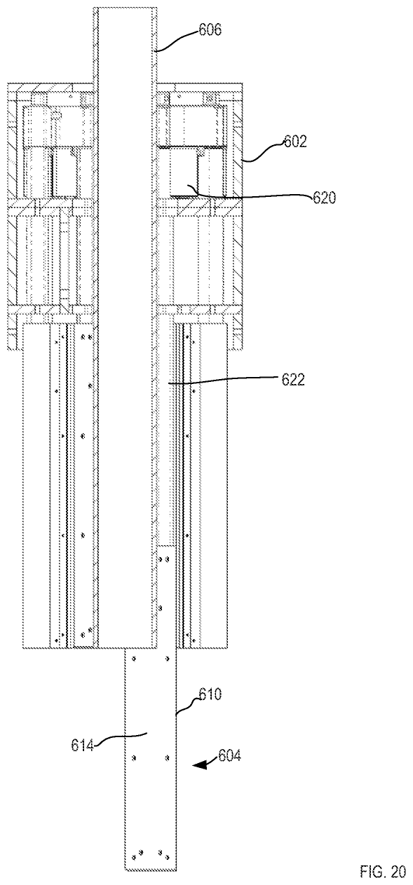

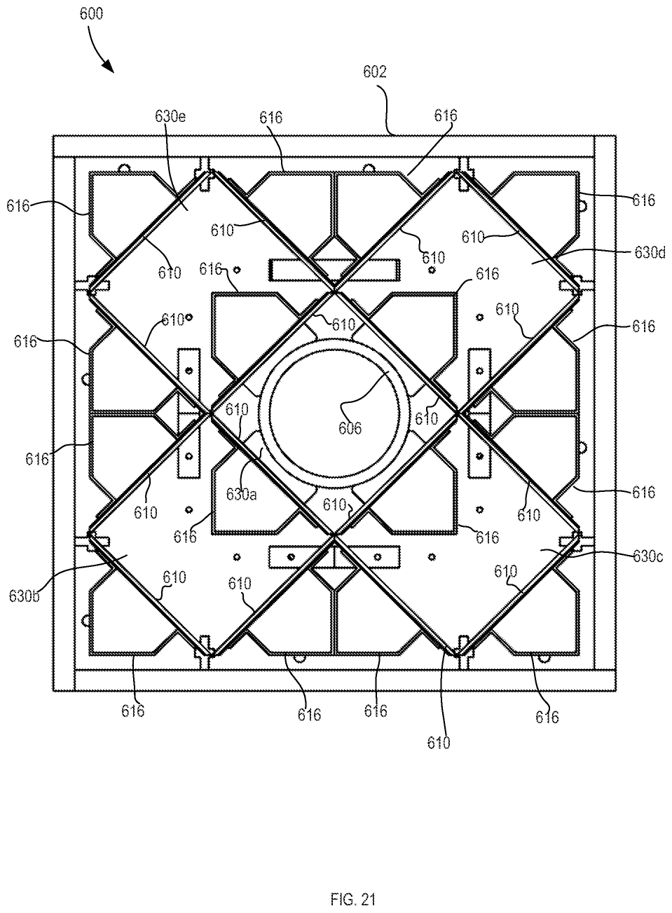

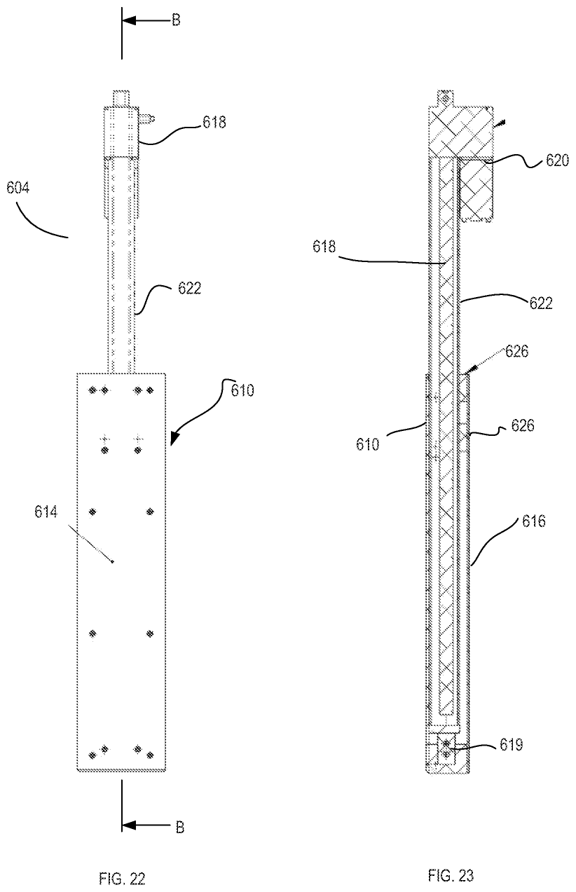

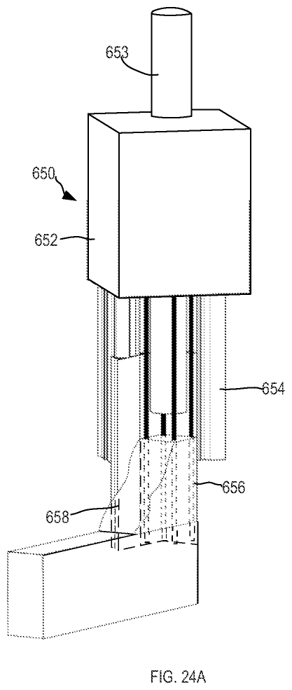

The head may have a variety of configurations and shapes, sizes, and movement mechanisms. FIG. 18 is a diagrammatic representation of an isometric view of one embodiment of a head 600, which may be one example of a head 102, FIG. 19 is a diagrammatic representation of a front view of one embodiment of the head 600, FIG. 20 is an A-A cross-sectional view of the embodiment of FIG. 19, FIG. 21 is a diagrammatic representation of a bottom view of one embodiment of the head 600, FIG. 22 is a diagrammatic representation of one embodiment of a blade assembly 604 of the head 600 and FIG. 23 is a B-B cross-sectional view of the embodiment of FIG. 22. The head 600 may be mounted to a head positioning system (e.g., head positioning system 104 of FIG. 1). The head 600 includes a chassis 602 that carries a plurality of blade assemblies (one blade assembly 604 is indicated in FIG. 18 for simplicity). In some embodiments, a consolidation element, such as one or more vibrators, may also be mounted to chassis 602. A material delivery system (e.g., material delivery system 106 of FIG. 1) provides material to head 600 via a material delivery hose 606 (e.g., a concrete delivery hose).

The head 600 includes an adjustable form into which material can be dispensed via the material delivery hose 606. In particular, the blade assemblies (e.g., blade assembly 604) can actuate blades up and down to shape a forming chamber into which material is dispensed. FIG. 22 is a diagrammatic representation of one embodiment of a blade assembly 604 and FIG. 23 is a cross-section B-B of the blade assembly 604 of FIG. 22. Each blade assembly includes a blade 610 that has a concrete face 614 to abut concrete in the forming chamber. The blade 610 is mounted to a bracket 616 or sleeve which is connected to a telescoping actuator 618, driven by motor 620. The bracket 616 is attached to the actuator by a fixed joint 619. Bushings 626 between the bracket and an outer sleeve 622 allow the bracket to slide along the sleeve 622 as the telescoping actuator 618 extends and retracts.

In the illustrated embodiment, actuator 618 is a motor driven actuator. Other embodiments may use other types of actuators, such as pneumatic or hydraulic actuators to actuate the form sections. Moreover, while each blade has its own actuator in the embodiment of head 600 illustrated, other embodiments may drive multiple blades (form sections) with a single actuator. For example, a single actuator can control two or more blades. For example, twelve actuators may be used to control sixteen blades. In another embodiment, a transmission/clutch system can be used so that one motor can be applied to multiple blades as selected by the transmission/clutch.

With reference to FIG. 21, the head 600 can include a number of blade assemblies. In this embodiment, the adjustable form comprises a plurality of blades 610 that act as form sections. The blades 610 may be selectively actuated to create a forming chamber that comprises chamber portion 630a into which material is dispensed through material delivery hose 606 and zero or more of chamber portion 630b, chamber portion 630c, chamber portion 630d, or chamber portion 630e into which material can flow. Thus, the forming chamber into which material is dispensed can be dynamically changed by actuating the blades.

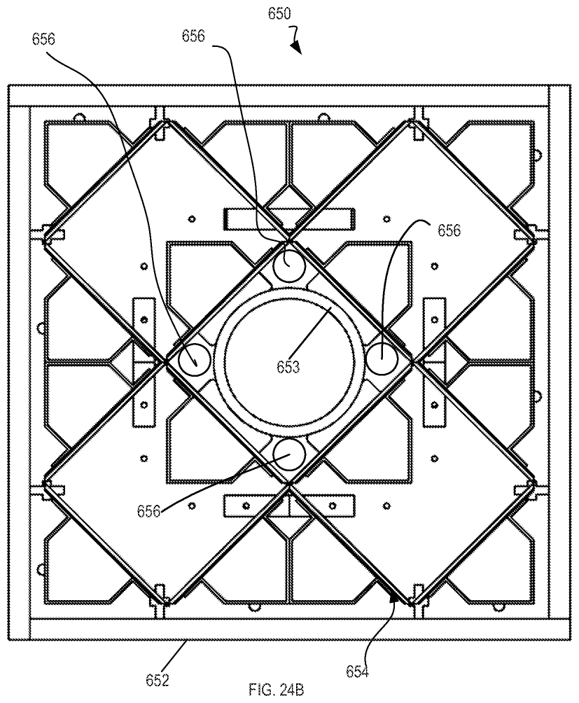

FIG. 24A is a diagrammatic representation of an isometric view of another embodiment of a head 650, which includes a chassis 652 that carries a plurality of blade assemblies 654 and vibrators 656 and FIG. 24B is a bottom view of head 650. The plurality of blade assemblies 65 can be selectively actuated to create a forming chamber having a desired shape. A material delivery hose 653 delivers material to the forming chamber. Head 650 is similar to head 600 but includes vibrators 656 that are coupled to actuators or a single actuator that controls multiple vibrators. The vibrators 656 can be lowered into a material (e.g., material 658) in the forming chamber and retracted when not in use.

In the examples of head 200, head 502, head 600, and head 650 the heads each have sixteen form sections arranged in a set of squares. However, in other embodiments there may be more form sections or fewer form sections. Further, the form sections may be of different lengths to create chamber portions of various sizes. Moreover, embodiments are not limited to form sections that have straight faces. In some embodiments, one or more of the form sections (e.g., blades) may have a curved face that faces the material being molded (e.g., a curved concrete face) or a face that has some other static or dynamically adjustable profile.

Furthermore, in some embodiments, the actuators of a head (e.g., head 200, head 502, head 600) can position the respective form sections in any position in a range of positions from a fully extended position to a fully retracted position.

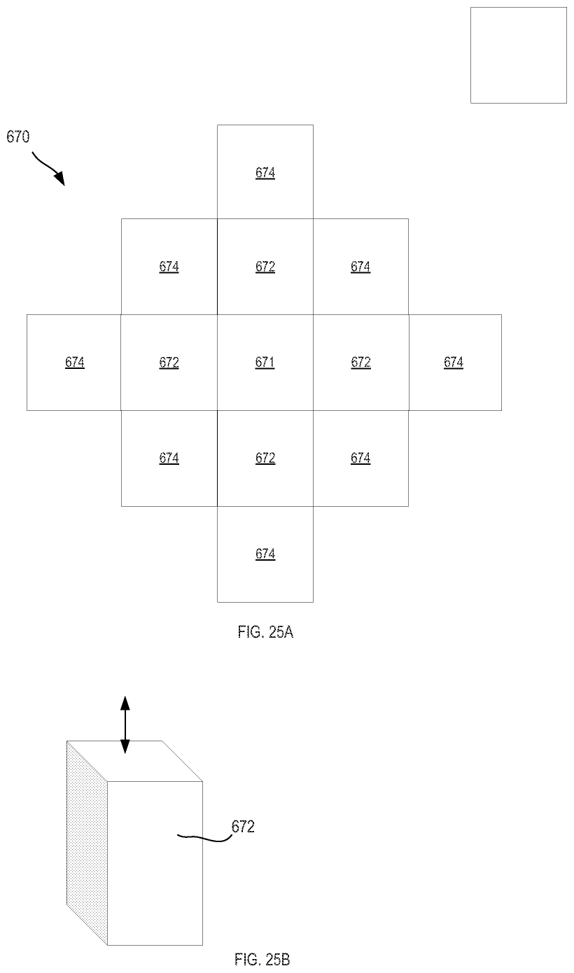

In yet other embodiments, the adjustable form may comprise a set of blocks or bars that can be actuated to fill or expose chamber portions to shape the forming chamber. The blocks or bars may have any desired shape, such as squares, triangles, combinations of geometric shapes. For example, FIG. 25A illustrates one embodiment of a head 670 having a center chamber 671 into which material can be dispensed. Blocks 672 can be retracted or extended (as illustrated in FIG. 25B) to selectively connect additional chamber sections to the center chamber 671. Blocks 674 may be stationary or may also be able to move up and down. Thus, the forming chamber is defined by a set of blocks that act as form sections. In other embodiments, blocks may have any number of other shapes.

In some embodiments, the form sections of an adjustable form may move horizontally outward to facilitate releasing the material in the forming chamber.

In some embodiments, seals are provided between form sections to prevent leakage. In addition, or in the alternative, physical, electromechanical, or electromagnetic alignment features are incorporated into the form sections to ensure that they maintain coplanarity, or orthogonality, or other desirable alignments in its various configurations.

The adjustable form may incorporate some degree of compliance using springs, air or other mechanisms, allowing for passive adjustment to slight variations in material properties.

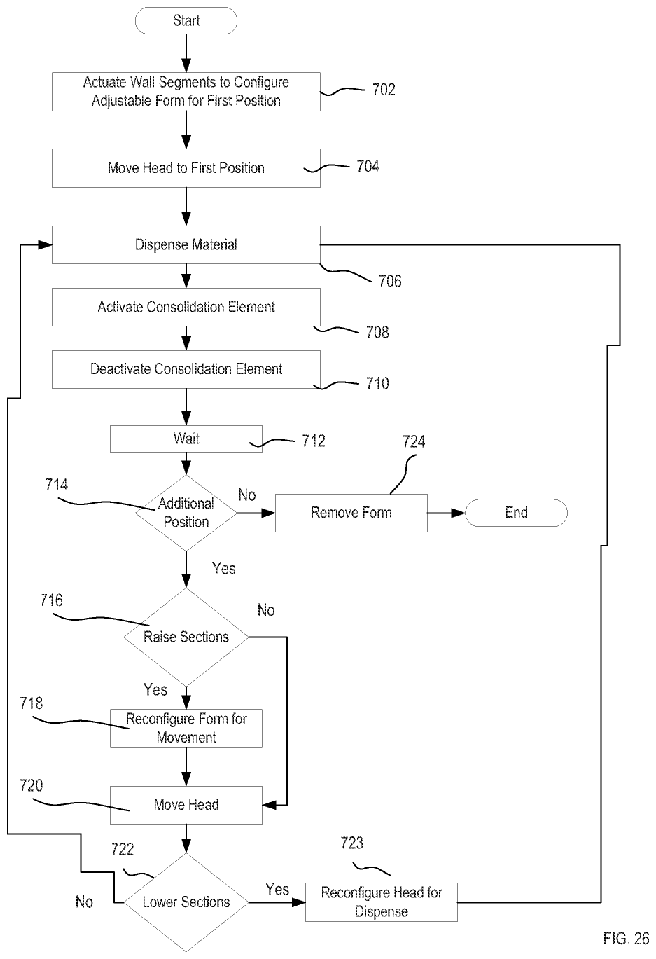

FIG. 26 is a flowchart for one embodiment of a method for building an object using additive manufacturing. In some embodiments, the various steps may be controlled by a control system, such as control system 108. One or more steps may be embodied in computer software for controlling manufacturing according to a 3D design. At step 702, the control system 108 controls the adjustable form 110 to create a forming chamber having a shape corresponding to a starting location for building the object. At step 704, the control system 108 controls the head positioning system 104 to position the head 102 at the first position. At step 706, the control system 108 controls the material delivery system 106 to dispense a predetermined volume of material—for example, a cementitious material in some embodiments—into the forming chamber at the first location. In some embodiments, the control system 108 dynamically controls adding admixes to the material at the time of dispensing to achieve desired material properties.

At step 708, the control system 108 controls the head 102 to activate a consolidation element. This may include, for example, actuating the consolidation element to lower the consolidation element into the newly dispensed material prior to activating the consolidation element. In other embodiments, consolidation, if performed, is performed by human laborers or additional automated equipment. In still other embodiments, consolidation, if performed, is achieved by transmission of energy without direct contact with the casting material, e.g., using electromagnetic, magnetic, or sonic waves. When the material has been consolidated for a sufficient period of time, for example as programmatically determined, the consolidation element is deactivated and removed from the material (step 710).

In some embodiments, the consolidation element is activated prior or during being moved into the material in the forming chamber so that it is imparting consolidation energy immediately upon contacting the material in the forming chamber. Further, in some embodiments, the consolidation element remains activated during the movement to remove it from the material. Using the example of head 200, the vibrators of consolidation element 206 may be activated prior to the vibrators being lowered into the material in forming chamber 230 (see e.g., FIG. 4C, FIG. 5D, FIG. 13B) and remain activated until they are lifted clear of the material in the forming chamber.

The system may wait before removing the form from the location (step 712). In a particular embodiment, the system waits a sufficient period of time to allow the material (e.g., the cementitious material) to stiffen so that the material can hold its shape without support from the adjustable form 110. For example, the material may be allowed to achieve an early set—that is, an initial set in which some strength is gained but the material remains workable and can be relaxed by agitation. In some embodiments, a cementitious material is maintained in the adjustable form 110 until it achieves a shape-holding state. As will be appreciated by those of skill in the art, the amount of wait time will depend on a variety of factors, including the volume and properties of the material dispensed, environmental factors, and other factors. In some embodiments, the material may stiffen sufficiently immediately or almost immediately upon cessation of consolidation energy.

The control system 108 determines from the object design if additional material should be dispensed at another location (step 714). If the object is complete, the adjustable form can be removed (step 724) and the process ends. If building the object requires adding material at additional locations, the control system determines if the configuration of the adjustable form 110 to be used at the next location has any form sections that are raised in that configuration, but not raised in the current configuration (step 716). If so, those form sections are raised (step 718) and the head moved to the next location (step 720). If not, the head can be moved to the next location (step 720). The control system 108 determines if the configuration of the adjustable head to be used to cast material at the current location has any form sections that are lowered in that configuration, but not lowered in the current configuration. If not, control can return to step 706. If so, the appropriate form sections are lowered (step 723) and control returns to step 706.

Thus, with the head 102 at the new location and the adjustable form 110 in the correct configuration for that location, control can pass to step 706. The new material can be dispensed, consolidated as needed, which may include consolidating previously dispensed material as well, and allowed to stiffen to a shape-holding state before removing the adjustable form 110. These steps can be repeated for each location until the object is complete.

Various steps include reconfiguring the adjustable form 110. According to one embodiment, the adjustable form 110 may be configured by controlling the head 102 to selectively raise or lower form sections to achieve a forming chamber shape appropriate for a location or to allow the head to move to a next location. In an even more particular embodiment, actuators may be controlled to raise or lower blades or other form sections as appropriate.

Further, some embodiments include consolidating material. Consolidation at step 708 may include applying a consolidation mechanism, such as vibration, to both the newly dispensed material in the forming chamber as well as previously dispensed material so that the newly formed material fills the forming chamber to have a shape at least partially defined by the form or the previously dispensed material, is void free, and has mechanically intermixed with horizontally or vertically adjacent previously cast sections.

Further, in some embodiments, an intermediate configuration may include setting a form section to scrape the top surface of a layer as the head 102 moves. For example, at the time that the last layer of the object is being formed, the head 102 may use elements of the adjustable form 110 to scrape the top surface of the layer, thus leveling or screeding the surface.

In some embodiments, a location may correspond to a layer that is on top of a previous layer. The head may be positioned so that the ends of the adjustable form 110 extend below the top surface of the preceding layer allowing the top surface of the preceding layer to be reliquified, mechanically intermixed with the current layer, all while being held within the extended adjustable form.

FIG. 26 is provided by way of example, but not limitation. Various steps may be repeated as needed or desired. Further, steps may be performed in different orders. As just one example, in some instances the head 102 may be moved while or before reconfiguring the adjustable form 110 for a next location. Steps may be omitted, and additional or alternative steps performed.

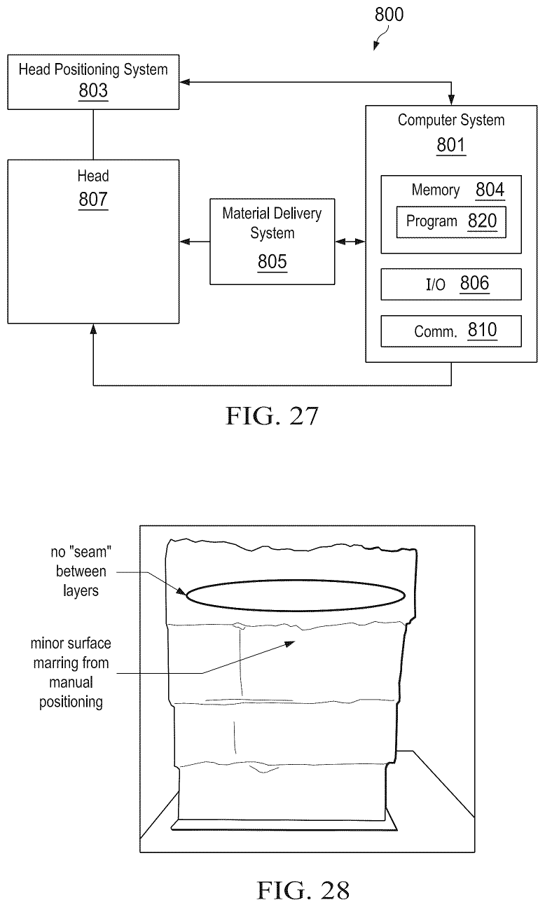

Embodiments of the technology may be implemented on a computing system. Any combination of mobile desktop, server, embedded or other types of hardware may be used. FIG. 27 is a diagrammatic representation of one embodiment of a computing environment 800 where embodiments disclosed herein can be implemented. The computing environment includes a computer system 801, connected to a head positioning system 803, a material delivery system 805, and a head 807 via communications links. The communications links may include, for example, a network, or various serial communications links for controlling devices or other communications links. A communicating link may represent a combination of wired and wireless networks that the computing environment may utilize for various types of communications.

Computer system 801 may include, for example, a computer processor 802 and associated memory 804. Computer processor 802 comprises an integrated circuit for processing instructions. For example, the computer processor 802 may comprise one or more cores or micro-cores of a processor. Memory 804 may include volatile memory, non-volatile memory, semi-volatile memory, or a combination thereof. Memory 804, for example, may include RAM, ROM, flash memory, a hard disk drive, a solid-state drive, an optical storage medium (e.g., CD-ROM), or other computer readable memory or combination thereof. Memory 804 may implement a storage hierarchy that includes cache memory, primary memory or secondary memory. In some embodiments, memory 804 may include storage space on a data storage array. Computer system 801 may also include input/output (“I/O”) devices 806, such as a keyboard, monitor, printer, electronic pointing device (e.g., mouse, trackball, stylus, etc.), or the like. Computer system 801 may also include a communication interface 810, such as a network interface card, or other communications interface, to interface with the communications links.

Memory 804 may store instructions executable by the computer processor 802. For example, memory 804 may include a control program 820 to control the head positioning system 803, the material delivery system 805, and the head 807 to additively manufacture objects. Thus, computer system 801 may be one embodiment of a control system 108.

The computer system 801 may be coupled to a data store that stores data usable by the control program 820. According to one embodiment, the data store may comprise one or more databases, one or more file systems or a combination thereof. In some embodiments, the data store is a portion of memory 804.

For the purpose of illustration, a single computer system is shown for computer system 801. However, computer system 801 may include a plurality of interconnected computers. For example, a plurality of computers may be coupled to a network. Computer system 801 may have more than one processor, memory or other hardware component, though, for the sake of brevity, computer system 801 is illustrated as having one of each of the hardware components, even if more than one is used. Methods or portions thereof described herein may be implemented through execution of suitable software code that may reside within memory 804.

FIG. 28 depicts a wall additively constructed as described herein using manual positioning of an adjustable form and manual consolidation, and without leveling the top layer. The wall does not have cold seams between the layers and is cast as a monolithic structure.

Those skilled in the relevant art will appreciate that the embodiments can be implemented or practiced in a variety of computer system configurations including, without limitation, multi-processor systems, network devices, mini-computers, mainframe computers, data processors, and the like. Embodiments can be employed in distributed computing environments, where tasks or modules are performed by remote processing devices, which are linked through a communications network such as a LAN, WAN, and/or the Internet. In a distributed computing environment, program modules or subroutines may be located in both local and remote memory storage devices. These program modules or subroutines may, for example, be stored or distributed on computer-readable media, stored as firmware in chips, as well as distributed electronically over the Internet or over other networks (including wireless networks). Example chips may include Electrically Erasable Programmable Read-Only Memory (EEPROM) chips.

Embodiments described herein can be implemented in the form of control logic in software or hardware or a combination of both. The control logic may be stored in an information storage medium, such as a computer-readable medium, as a plurality of instructions adapted to direct an information processing device to perform a set of steps disclosed in the various embodiments. Based on the disclosure and teachings provided herein, a person of ordinary skill in the art will appreciate other ways and/or methods to implement the invention. Steps, operations, methods, routines or portions thereof described herein be implemented using a variety of hardware, such as CPUs, application specific integrated circuits, programmable logic devices, field programmable gate arrays, optical, chemical, biological, quantum or nanoengineered systems, or other mechanisms.

Software instructions in the form of computer-readable program code may be stored, in whole or in part, temporarily or permanently, on a non-transitory computer readable medium. The computer-readable program code can be operated on by a processor to perform steps, operations, methods, routines or portions thereof described herein. A “computer-readable medium” is a medium capable of storing data in a format readable by a computer and can include any type of data storage medium that can be read by a processor. Examples of non-transitory computer-readable media can include, but are not limited to, volatile and non-volatile computer memories, such as RAM, ROM, hard drives, solid state drives, data cartridges, magnetic tapes, floppy diskettes, flash memory drives, optical data storage devices, compact-disc read-only memories. In some embodiments, computer-readable instructions or data may reside in a data array, such as a direct attach array or other array. The computer-readable instructions may be executable by a processor to implement embodiments of the technology or portions thereof.

A “processor” includes any hardware that processes data, signals or other information. A processor can include a system with a general-purpose central processing unit, multiple processing units, dedicated circuitry for achieving functionality, or other systems. Processing need not be limited to a geographic location or have temporal limitations. For example, a processor can perform its functions in “real-time,” “offline,” in a “batch mode,” etc. Portions of processing can be performed at different times and at different locations, by different (or the same) processing systems.

Different programming techniques can be employed such as procedural or object oriented. Any suitable programming language can be used to implement the routines, methods or programs of embodiments of the invention described herein, including R, Python, C, C++, Java, JavaScript, HTML, or any other programming or scripting code, etc. Communications between computers implementing embodiments can be accomplished using any electronic, optical, radio frequency signals, or other suitable methods and tools of communication in compliance with known network protocols.

Any particular routine can execute on a single computer processing device or multiple computer processing devices, a single computer processor or multiple computer processors. Data may be stored in a single storage medium or distributed through multiple storage mediums. In some embodiments, data may be stored in multiple databases, multiple filesystems or a combination thereof.

Although the steps, operations, or computations may be presented in a specific order, this order may be changed in different embodiments. In some embodiments, some steps may be omitted. Further, in some embodiments, additional or alternative steps may be performed. In some embodiments, to the extent multiple steps are shown as sequential in this specification, some combination of such steps in alternative embodiments may be performed at the same time. The sequence of operations described herein can be interrupted, suspended, or otherwise controlled by another process, such as an operating system, kernel, etc. The routines can operate in an operating system environment or as stand-alone routines. Functions, routines, methods, steps and operations described herein can be performed in hardware, software, firmware or any combination thereof.

It will be appreciated that one or more of the elements depicted in the drawings/figures can also be implemented in a more separated or integrated manner, or even removed or rendered as inoperable in certain cases, as is useful in accordance with a particular application. Additionally, any signal arrows in the drawings/figures should be considered only as exemplary, and not limiting, unless otherwise specifically noted.

In the description herein, numerous specific details are provided, such as examples of components and/or methods, to provide a thorough understanding of embodiments of the invention. One skilled in the relevant art will recognize, however, that an embodiment may be able to be practiced without one or more of the specific details, or with other apparatus, systems, assemblies, methods, components, materials, parts, and/or the like. In other instances, well-known structures, components, systems, materials, or operations are not specifically shown or described in detail to avoid obscuring aspects of embodiments of the invention. While the invention may be illustrated by using a particular embodiment, this is not and does not limit the invention to any particular embodiment and a person of ordinary skill in the art will recognize that additional embodiments are readily understandable and are a part of this invention.

As used herein, the terms “comprises,” “comprising,” “includes,” “including,” “has,” “having,” or any other variation thereof, are intended to cover a non-exclusive inclusion. For example, a process, product, article, or apparatus that comprises a list of elements is not necessarily limited only to those elements but may include other elements not expressly listed or inherent to such process, product, article, or apparatus.

Furthermore, the term “or” as used herein is generally intended to mean “and/or” unless otherwise indicated. For example, a condition A or B is satisfied by any one of the following: A is true (or present) and B is false (or not present), A is false (or not present) and B is true (or present), and both A and B are true (or present). As used herein, a term preceded by “a” or “an” (and “the” when antecedent basis is “a” or “an”) includes both singular and plural of such term, unless clearly indicated within the claim otherwise (i.e., that the reference “a” or “an” clearly indicates only the singular or only the plural). Also, as used in the description herein and throughout the meaning of “in” includes “in” and “on” unless the context clearly dictates otherwise.

Reference throughout this specification to “one embodiment”, “an embodiment”, or “a specific embodiment” or similar terminology means that a particular feature, structure, or characteristic described in connection with the embodiment is included in at least one embodiment and may not necessarily be present in all embodiments. Thus, respective appearances of the phrases “in one embodiment”, “in an embodiment”, or “in a specific embodiment” or similar terminology in various places throughout this specification are not necessarily referring to the same embodiment. Furthermore, the particular features, structures, or characteristics of any particular embodiment may be combined in any suitable manner with one or more other embodiments. It is to be understood that other variations and modifications of the embodiments described and illustrated herein are possible in light of the teachings herein and are to be considered as part of the spirit and scope of the invention.

Additionally, any examples or illustrations given herein are not to be regarded in any way as restrictions on, limits to, or express definitions of, any term or terms with which they are utilized. Instead, these examples or illustrations are to be regarded as being described with respect to one particular embodiment and as illustrative only. Those of ordinary skill in the art will appreciate that any term or terms with which these examples or illustrations are utilized will encompass other embodiments which may or may not be given therewith or elsewhere in the specification and all such embodiments are intended to be included within the scope of that term or terms. Language designating such nonlimiting examples and illustrations includes, but is not limited to: “for example,” “for instance,” “e.g.,” “in one embodiment.”

Thus, while the invention has been described with respect to specific embodiments thereof, these embodiments are merely illustrative, and not restrictive of the invention. Rather, the description (including the Abstract and Summary) is intended to describe illustrative embodiments, features and functions in order to provide a person of ordinary skill in the art context to understand the invention without limiting the invention to any particularly described embodiment, feature or function, including any such embodiment feature or function described. While specific embodiments of, and examples for, the invention are described herein for illustrative purposes only, various equivalent modifications are possible within the spirit and scope of the invention, as those skilled in the relevant art will recognize and appreciate.

As indicated, these modifications may be made to the invention in light of the foregoing description of illustrated embodiments of the invention and are to be included within the spirit and scope of the invention. Thus, while the invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the invention.

Benefits, other advantages, and solutions to problems have been described above with regard to specific embodiments. However, the benefits, advantages, solutions to problems, and any component(s) that may cause any benefit, advantage, or solution to occur or become more pronounced are not to be construed as a critical, required, or essential feature or component.

1. A method of additive manufacturing comprising:
moving a head to a plurality of positions corresponding to a plurality of dispense locations in a build volume, the head comprising an adjustable form configurable to define a forming chamber for forming a material at the plurality of dispense locations;
configuring the adjustable form to shape the forming chamber for each of the plurality of dispense locations; and
casting a three-dimensional object, casting the three-dimensional object comprising dispensing a portion of the material into the forming chamber at each of the plurality of dispense locations.

2. The method of claim 1, wherein the material is a cementitious material.

3. The method of claim 1, further comprising consolidating the portion of the material dispensed into the forming chamber at each of the plurality of dispense locations.

4. The method of claim 3, wherein the three-dimensional object is a monolithic three-dimensional object.

5. (canceled)

6. (canceled)

7. (canceled)

8. (canceled)

9. The method of claim 1, wherein dispensing the portion of the material at each of the plurality of dispense locations comprises building the three-dimensional object by stacking a plurality of layers.

10. The method of claim 9, further comprising consolidating the portion of the material dispensed into the forming chamber at each of the plurality of dispense locations, wherein consolidating the portion of the material dispensed into the forming chamber at each of the plurality of dispense locations comprises consolidating a portion of a current layer and a portion of a previous layer below the portion of the current layer to intermix the portion of the current layer and the portion of the previous layer.

11. (canceled)

12. The method of claim 1, wherein the adjustable form comprises a plurality of form sections and wherein configuring the adjustable form comprises selectively actuating form sections from the plurality of form sections to configure the forming chamber to have a plurality of shapes, the plurality of shapes comprising a first shape to form a straight portion of the 3-D object and a corner shape to shape a corner portion of the 3-D object.

13. (canceled)

14. The method of claim 1, further comprising consolidating the portion of the material dispensed into the forming chamber at each of the plurality of dispense locations comprises lowering a vibrator into the portion of the material and activating the vibrator, and wherein the method further comprises raising the vibrator prior to moving the head from a current position to a next position.

15. (canceled)

16. (canceled)

17. A computer program product comprising a non-transitory, computer-readable medium storing a set of computer-executable instructions, the set of computer-executable instructions comprising instructions for:
positioning a head at a plurality of positions corresponding to a plurality of dispense locations in a build volume, the head comprising an adjustable form configurable to define a forming chamber for forming a material at the plurality of dispense locations;
automatically configuring the adjustable form to shape the forming chamber for each of the plurality of dispense locations; and
casting a three-dimensional object, casting the three-dimensional object comprising dispensing a portion of the material into the forming chamber at each of the plurality of dispense locations.

18. (canceled)

19. (canceled)

20. (canceled)

21. (canceled)

22. (canceled)

23. (canceled)

24. (canceled)

25. (canceled)

26. The computer program product of claim 17, further comprising instructions for lowering a vibrator into the portion of the material, activating the vibrator, and raising the vibrator prior to moving the head from a current position to a next position.

27. (canceled)

28. A system for additive manufacturing comprising:
a head comprising an adjustable form for casting a material, the adjustable form configurable to define a forming chamber, the adjustable form comprising a plurality of form sections that are selectively movable to create the forming chamber in a plurality of shapes; and
a head positioning system to position the head in build volume.

29. The system of claim 28, wherein the material is a cementitious material.

30-37. (canceled)

38. The system of claim 28, wherein the plurality of form sections comprises a plurality of retractable blades, wherein the head comprises a plurality of actuators coupled to the plurality of retractable blades to raise and lower the plurality of retractable blades to selectively define the forming chamber, wherein the forming chamber comprises a central chamber portion and an adjacent chamber portion selectively joinable to the central chamber portion based on a configuration of the plurality of form sections, wherein the head dispenses material from a top of the central chamber portion, and wherein the forming chamber is configurable in a plurality of shapes, the plurality of shapes comprising a first shape to form a straight portion of a 3-D object and a corner shape to shape a corner portion of a 3-D object.

39. (canceled)

40. (canceled)

41. (canceled)

42. A device for additive manufacturing comprising:
an adjustable form for casting a material, the adjustable form configurable to define a forming chamber, the adjustable form comprising a plurality of form sections that are selectively movable to create the forming chamber in a plurality of shapes; and
a flow path fluidly connected to the adjustable form to deliver the material to the forming chamber.

43. The device of claim 42, wherein the material is a cementitious material.

44. The device of claim 42, further comprising a consolidation element to consolidate the material in the forming chamber.

45. (canceled)

46. The device of claim 42, further comprising a vibrator for consolidating the material in the forming chamber, wherein the vibrator is a form vibrator that vibrates the adjustable form.

47. The device of claim 42, further comprising a vibrator for consolidating the material in the forming chamber, wherein the vibrator is movable within the forming chamber from a retracted position to a lowered position.

48. The device of claim 42, further comprising a vibrator for consolidating the material in the forming chamber, wherein the vibrator is a rod vibrator.

49. The device of claim 42, further comprising:
a plurality of actuators coupled to the plurality of form sections to raise and lower the plurality of form sections to selectively define the forming chamber, wherein the plurality of form sections comprises a plurality of retractable blades, wherein the forming chamber comprises a central chamber portion and an adjacent chamber portion selectively joinable to the central chamber portion based on a configuration of the plurality of form sections, wherein the flow path is open to a top of the central chamber portion and wherein the forming chamber is configurable in a plurality of shapes, the plurality of shapes comprising a first shape to form a straight portion of a 3-D object and a corner shape to shape a corner portion of a 3-D object.

50. (canceled)

51. (canceled)

52. (canceled)

53. (canceled)

54. The system of claim 28, wherein the head comprises a consolidation element.

55. The system of claim 28, further comprising:
a material source to provide the material to the head, wherein the head comprises a material delivery path to direct material received from the material source to the forming chamber;
a computer system in communication with the head, the head positioning system and the material source, the computer system comprising a processor and a non-transitory, computer-readable medium storing instructions executable by the processor for controlling the head positioning system, the head, and the material source to cast a three-dimensional object using the head, wherein casting the three-dimensional object comprises:
moving the head to a plurality of positions corresponding to a plurality of dispense locations in a build volume;
automatically configuring the adjustable form to shape the forming chamber for each of the plurality of dispense locations; and
dispensing a portion of the material into the forming chamber at each of the plurality of dispense locations.

56. The system of claim 55, wherein the head comprises a vibrator and wherein casting the three-dimensional object comprises using the vibrator to consolidate the portion of the material dispensed into the adjustable form at each of the plurality of dispense locations.

57. The system of claim 56, wherein casting the three-dimensional object comprises using the vibrator to consolidate adjacent portions of the material into a monolithic structure.

58. The system of claim 56, wherein the vibrator is a form vibrator that vibrates the adjustable form.

59. The system of claim 56, wherein the vibrator is movable in the forming chamber from a retracted position to a lowered position.
